(19) United States
(12) Patent Application Publication
(10) Pub. No.: US 2008/0097898 A1
(43) Pub. Date: Apr. 24, 2008

(54) Transaction management system

(75) Inventors: Errington Winfield Hibbert, Scotch Plains, NJ (US); Amy Huntington, New York, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Holdings Inc., Jersey City, NJ (US)

(21) Appl. No.: 11/978,622

(22) Filed: Oct. 30, 2007

Related U.S. Application Data
(62) Division of application No. 10/080,902, filed on Feb. 22, 2002.

(51) Int. Cl. G06Q 40/00

(52) U.S. Cl. 705/38

(57) ABSTRACT

The present invention is directed towards methods, apparatuses, and systems for facilitating and enhancing processes associated with financial transactions. The present invention monitors and manages transaction-level work flows, and facilitates coordination of the tasks and operations associated with financial transactions. Embodiments of the present invention also allow for automation of various deal management, collateral analysis and due diligence processes associated with financial transactions. In one embodiment, the present invention facilitates tasks and processes associated with the purchase and sale of whole loans.

This application is a divisional application of U.S. patent application Ser. No. 10/080,902, filed Feb. 22, 2002, which is incorporated herein by reference.

### FIELD OF THE INVENTION

The present invention relates to transaction management and, more particularly, to methods, apparatuses and systems facilitating analysis and management functions associated with financial transactions, such as the origination, purchase and sale of secured and unsecured assets, such as mortgage loans.

### BACKGROUND OF THE INVENTION

Investment banks selling mortgage backed securities or bonds acquire the underlying assets through purchasing whole loans in the secondary market, or by originating the loans in the primary market. Specifically, an investment bank purchases packages or pools of whole loans from client banks (optionally holding them for a period of time), then repackages the loans based on a variety of criteria such as investor requirements for credit quality and yield, and sells them to institutional and other investors. The repackaged loans can be converted into mortgage-backed securities or bonds, or simply sold as a new pool of loans.

The process of buying and selling secured and unsecured assets, such as whole loans, is a labor intensive process requiring the participation and cooperation of several departments and persons, both internal and external to an investment bank. The participants in a whole loan transaction, for example, must analyze a vast array of loan data and documentation, as well as negotiate and finalize the terms of all purchase and related agreements. Indeed, a whole loan transaction involves the purchase of hundreds, and often thousands, of individual loans and, therefore, requires the dedication of significant human resources for analysis and evaluation of massive amounts of data. Traditionally, a whole loan transaction, however, is an extremely manual and inefficient process. On the purchasing side, a whole loan transaction typically involves a myriad of exchanges of telephone calls, information formats, databases, documents, reports, and emails, many of which are not communicated clearly or never received, often necessitating repeated requests for the same reports and data. For example, a typical investment bank may have multiple active deals involving the same client, often rendering it difficult for the participants to know to which transaction a particular communication applies.

In a typical transaction, a client financial entity, such as a bank, investment bank, or other mortgage dealer, offers a package or pool of loans for sale. Often, the client bank provides a bid deadline, compares all bids received within the deadline, and notifies the winner. Sometimes, however, the client bank leaves the offer open-ended, thereby creating a race among competing bidders.

To allow for assessment and valuation of the loan pool, the client bank makes available loan data, usually in spread sheet files or other computer data formats. The loan data is a representation of the information contained in the actual loan file that was utilized in the credit granting process of a consumer. Secondary market players such as investment banks are alerted to available loan packages either through direct relationships with the seller or through their sales forces. Most secondary market players maintain a sales force that covers the various banks and other whole loan sellers in the primary market. The sales force forwards data file(s) for the appropriate loan package being offered by the seller to individual traders at the investment bank who may be interested in the transaction. An interested trader will then ask an analytics group to analyze the loan data and generate reports allowing for a preliminarily assessment of the value of the loan pool. The analytics group analyzes the loan data provided by the client bank and generates summary reports (e.g., bid stratification reports) characterizing the expected risk and return associated with the loans in the pool. These reports are critical to the pricing process, as they summarize the data on a large number of loans into a user-friendly format. Using such reports and general business and trading experience, the trader derives the optimal price for the pool of loans and offers a bid to purchase the pool.

If the trader desires to purchase the pool, she usually contacts the client bank by telephone or email and places a bid. The client bank then contacts the trader who placed the bid to communicate a rejection or acceptance of the bid, and/or any stipulations. At or close to the time of acceptance, the trader and the client bank negotiate a closing date and other deal points associated with the transaction. Upon acceptance, it is therefore incumbent on the trader to communicate acceptance of the bid to other departments within the investment bank. Beyond trusting the trader to notify requisite departments, there is no mechanism to facilitate that all departments will be notified or that the same information is communicated clearly to all involved parties. Some departments, such as “trade processing,” are automatically notified; however, the trader may not notify other departments required to complete the transaction (such as transaction management) until well after the bid is accepted and the closing date is quite near. This clearly creates issues in completing essential steps in the closing process such as negotiating agreements and obtaining accurate loan level data on the portfolio.

A client bank's acceptance of a bid sets off a range of activities, including negotiation of contracts between the client bank and the investment bank, more extensive analysis of the loan pool data (for data integrity purposes and any pricing adjustments), and due diligence activities by the investment bank. To accomplish these tasks, the investment bank assigns several people from various departments to the transaction. A deal manager is assigned to manage the transaction, negotiate agreements, and ensure that timelines and other requirements associated with the transaction are accomplished. Due diligence managers, tape/collateral analysts, middle office and back office personnel are also assigned to the transaction.

A deal manager manages the transaction to ensure, for example, that requisite due diligence, risk analysis, and fraud checks are performed. Deal managers also work with in-house or outside counsel to assist with the drafting and negotiation of agreements involved in the transaction. A due diligence manager manages the due diligence process to assess the loan pool from a credit and legal compliance perspective. The due diligence manager determines which loans to buy and assesses the adequacy of the contracts setting forth the terms of the transaction. Given the large amounts of data involved, the due diligence manager usually analyzes summary reports describing the loans in the pool, as well as individual loans from a selected sample of the loan pool, to took for potential problems. If the due diligence manager finds a potential problem, the loan(s) is chosen for the sample. Then the due diligence manager deploys an underwriting team for further inspection and analysis such as validating loan quality pursuant to the purchase contract and/or adherence to the operative underwriting guidelines, and performing data integrity checks. The underwriting team travels to the location of the loan files (usually the client bank, or document custodian, or loan servicer) in order to perform the loan level inspection and assess whether the loan should be purchased. Typical inspection criteria include risk of default, legality of the loan, loan origination practices, etc. Concurrently with due diligence activities, a tape or collateral analyst performs quantitative analysis on the loan pool data. For example, the tape analyst verifies data integrity, adequacy and completeness of the data. The tape analyst may also work with the trader to analyze the loan pool for pricing purposes. Ultimately, after requisite due diligence and analytics are completed, the trader re-prices the pool and takes ownership of the pool of loans.

Subsequent to the transaction, the investment bank must track down the documentation, reports and other data associated with the loans for purposes of repackaging and ultimately selling the loans. This may occur immediately or after a period of several months and requires amassing all agreements and documentation associated with the transaction. For example, conversion of a package of loans into mortgage-backed securities or bonds requires retrieval and collection of all relevant documentation. In addition, traders, working with tape analysts, must analyze loan data for purposes of achieving optimal execution and to meet any client or market demands around credit or risk profiles. Often times, however, the requisite documentation is dispersed among several departments within the investment bank and external entities, such as outside law firms, involved in the transaction. Moreover, the number of revisions to the various documents involved severely complicates the process of physically locating and verifying the final version of each document. Moreover, a securitization often involves twenty to thirty different loan portfolios in a securitization. Accordingly, the number of related agreements and other documentation can be massive.

In light of the foregoing, a need in the art exists for methods, apparatuses and systems that improve the efficiency and effectiveness of processes associated with financial transactions and, in particular, whole loan transactions. For example, given the large amounts of data involved and the constraints on the amount of time available to place a bid, the trader necessarily bases his bid and pricing decisions on a substantially limited amount of information, especially in consideration of the dollar values involved in the transactions. The trader also bases the bid on summary reports that do not allow efficient analysis of the credit nuances of the pool. In addition, once a bid is accepted, a transaction is rarely broken off in light of the costs of potential litigation and other considerations. Accordingly, a need in the art exists for methods, apparatuses and systems that provide for more detailed analysis of loan pool data prior to placing a bid. In addition, a need exists in the art for systems, methods, and apparatuses that reduce the time between trade commitment and purchase of assets, as well as between purchase of assets and a subsequent sale of those assets. Still further, a need exists for methods, apparatuses and systems that improve access to a critical mass of data, as well as risk management tools enhancing performance analysis and portfolio risk management. As the following description provides, embodiments of the present invention substantially fulfill these and other needs.

### SUMMARY OF THE INVENTION

The present invention provides methods, apparatuses and systems facilitating and enhancing processes associated with financial transactions. The present invention monitors and manages transaction-level work flows, and facilitates coordination of the tasks and operations associated with financial transactions. Embodiments of the present invention also allow for automation of various deal management, collateral analysis and due diligence processes associated with financial transactions. In one embodiment, the present invention facilitates tasks and processes associated with the purchase and sale of whole loans (mortgages and related assets).

### DESCRIPTION OF THE DRAWINGS

FIG. 1 is a functional block diagram illustrating a computer network environment including an embodiment of the present invention.

FIG. 2 is a functional block diagram setting forth the functionality of a transaction management system according to one embodiment of the present invention.

FIG. 3 is a table illustrating user groups and user roles according to an embodiment of the present invention.

FIG. 4 illustrates a deal home page according to an embodiment of the present invention.

FIG. 5A sets forth a purchase sheet interface according to an embodiment of the present invention.

FIGS. 5B1-5B2 illustrate a matrix providing the purchase sheet responsibilities for respective users according to an embodiment of the present invention.

FIGS. 6A-6D illustrate a table illustrating an arrangement of deal level and document folders according to an embodiment of the present invention.

FIG. 7 is a table setting forth the data fields for each loan record in loan tracking system 70 according to an embodiment of the present invention.

FIG. 8 illustrates a user interface facilitating the configuration of a new user account.

FIG. 9 illustrates a high risk report interface providing summary level data that details the risk associated with a loan pool.

FIG. 10 sets forth a loan-level detail interface corresponding to a selected high risk report category.

FIGS. 11A-11E provide user interfaces associated with the selection of an underwriting sample.

FIGS. 12A-12D illustrate a table providing the loan level data fields and operator descriptions according to an embodiment of the present invention. As discussed below, these fields can be queried in the database, such as while choosing a sample for underwriting or independently in order to extract data from the database that contains loan inventory.

FIG. 13 is a change log interface facilitating comparison of loan pool pricing variables before and after further analysis of the loan pool.

FIG. 14 is a query interface facilitating selection of loans based on loan data field values.

### DESCRIPTION OF PREFERRED EMBODIMENT(S)

I. Operating Environment

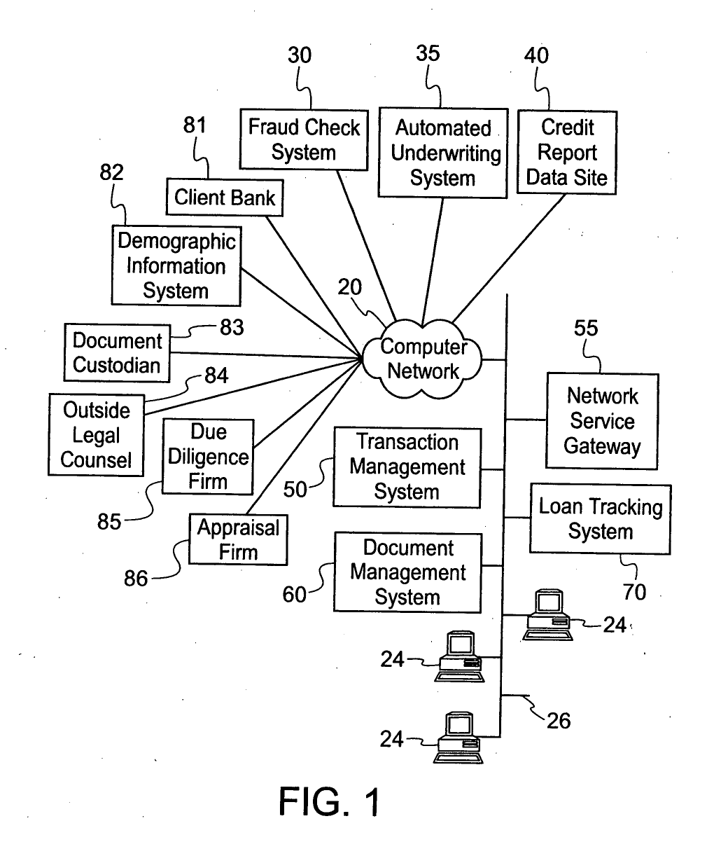

FIG. 1 sets forth a computer network environment including functionality associated with an embodiment of the present invention. Computer network 26, in one embodiment, is a Local Area Network (LAN) interconnecting a plurality of host nodes and systems. In one embodiment, computer network 26 and the nodes connected thereto are associated with an investment bank maintaining a transaction management system according to the present invention. Computer network 26, in one embodiment, includes client computers 24, transaction management system 50, network services gateway 55, document management system 60, and loan tracking system 70. As FIG. 1 illustrates, computer network 26 is operably connected to computer network 20 allowing for transmission of data between a host node, such as client computer 24, associated with computer network 26 and a plurality of external systems and/or enterprises. In one embodiment, such enterprises include fraud check system 30, automated underwriting system 35, and credit report data site 40. Such enterprises further include client bank 81, demographic information system 82, document custodian 83, outside legal counsel 84, due diligence firm 85, and appraisal firm 86.

As discussed in more detail below, transaction management system 50 implements software components and interfaces facilitating management of work flows associated with financial transactions. Network services gateway 55 processes and routes service action requests and responses associated with external and internal applications. Document management system 60 manages electronic documents and data associated with financial transactions. Loan tracking system 70 maintains a database of transaction-level and loan-level data.

A. System Architecture

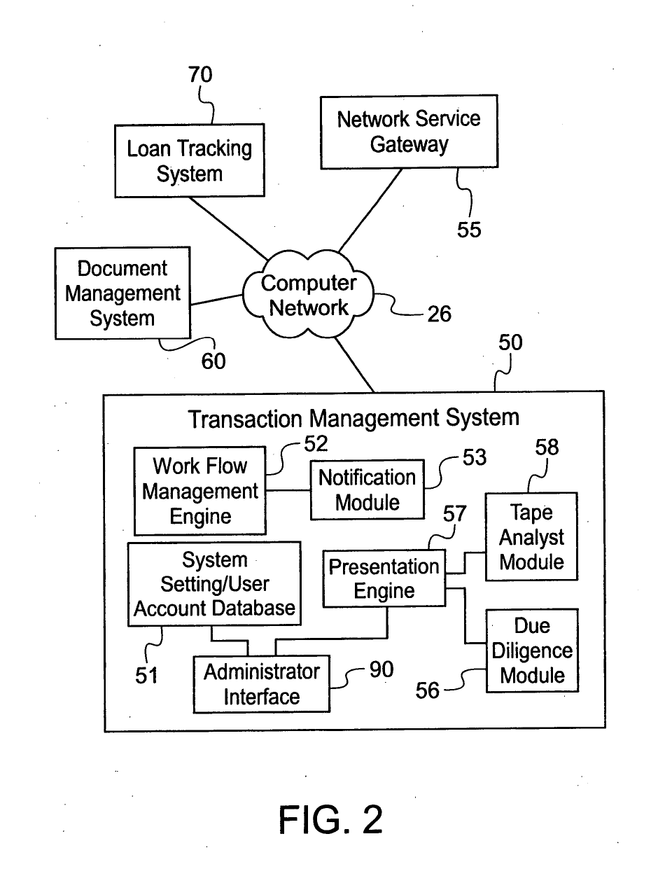

FIGS. 1 and 2 set forth a high-level architecture of a system according to one embodiment of the present invention.

A.1. Transaction Management System

Transaction management system 50 provides a central access point to the management, analysis, risk management, administrative and other functionality directed to processes and tasks associated with financial transactions, as more fully described below. As FIG. 2 provides, transaction management system 50 comprises work flow management engine 52 and notification module 53 that, in conjunction, are operative to facilitate coordination of users and tasks associated with financial transactions. Work flow management engine 52 supports a plurality of work flows each directed to different elements of various types of transactions (e.g., whole loan purchasing, lending, whole loan sales, whole loan securitizations, etc.). In one embodiment, each work flow comprises a set of predefined transaction events and associated actions that work flow management engine 52 executes in response. Work flow management engine 52 is operative to monitor the status of transactions in relation to the set of predefined transaction events associated with a work flow. As discussed below, upon the occurrence of particular events (e.g., the completion of a form, the receipt of data from an external service, etc.) associated with a transaction, work flow management engine 52 is operative to change transaction milestone or other status parameters associated with a transaction and/or individual loans associated with a transaction. Work flow management engine 52, in response to transaction events and/or milestones, is further operative to trigger notification module 53 to transmit notifications to required users. System settings/user account database 51 stores system settings and configurations, as well as user accounts associated with users of the system.

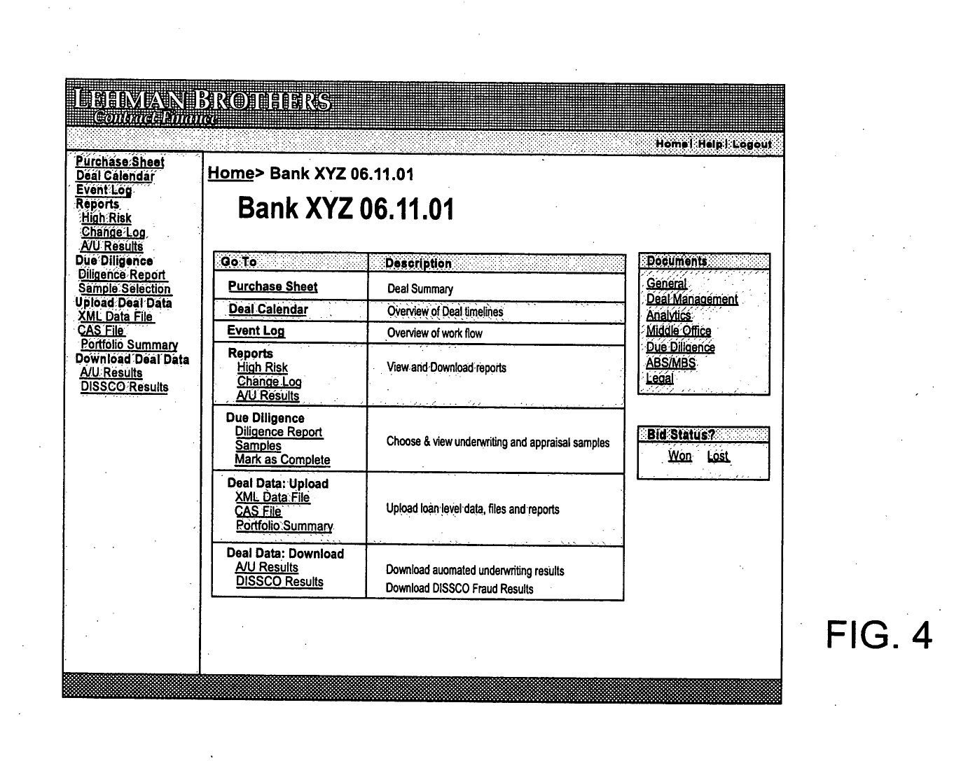

Transaction management system 50 includes web server or other functionality allowing for the generation of HTML pages in response to requests transmitted from client nodes. In one embodiment, transaction management system 50 provides page-based interfaces allowing access to data and functionality from any network access device that includes a browser or other suitable software. Transaction management system 50 provides web-based interfaces providing access to the functionality described herein, such as creation of new transactions and the entry of and/or access to data associated with each transaction at initiation, during the transaction process, and at closing. After a new transaction has been configured, transaction management system 50 presents a transaction or deal home page containing links to documents and data associated with the transaction, as well as to transaction-related services and other functionality. (See FIG. 4). In addition, transaction management system 50 is further operative to retrieve data from loan tracking system 70 and dynamically create and transmit pages (e.g., a purchase sheet) as users navigate to various pages associated with the transaction.

Internal users access transaction management system 50 over computer network 26 via client computers 24. External users and application services also have access to transaction management system 50 over wide area computer network 20, as discussed in more detail below. All internal and external users must log in and be authenticated before gaining access to transaction management system 50 and associated systems. In one embodiment, users provide user names and passwords for purposes of authentication. However, the exact authentication scheme is not critical to the present invention; any suitable authentication scheme can be employed.

Transaction management system 50 also includes functionality that supports tasks associated with various users involved in financial transactions. In one embodiment, transaction management system 50 further comprises administrator interface 90, due diligence module 56, tape analyst module 58 and presentation engine 57. Tape analyst module 58 provides functionality and interfaces facilitating the ordering of internal and external services and the generation of reports. Due diligence module 56 facilitates the selection of due diligence and appraisal samples, as well as the generation of reports. Presentation engine 57 is operative to extract data from loan tracking system 70 and generate reports according to predefined templates.

A.1.a. Deal Home Page and Purchase Sheet

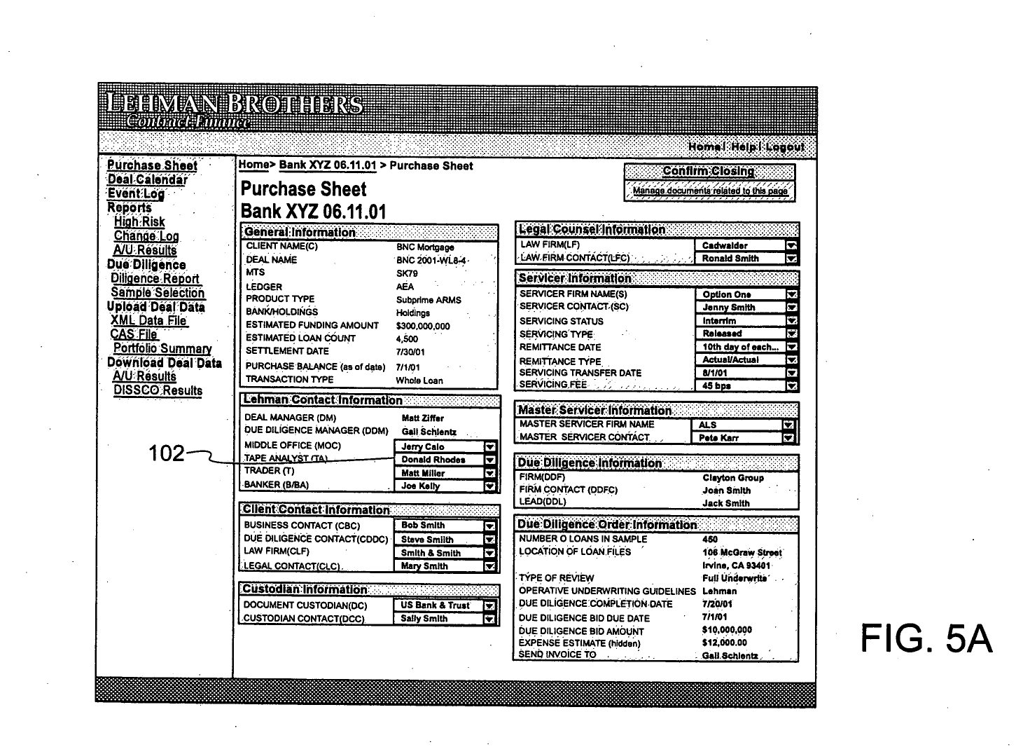

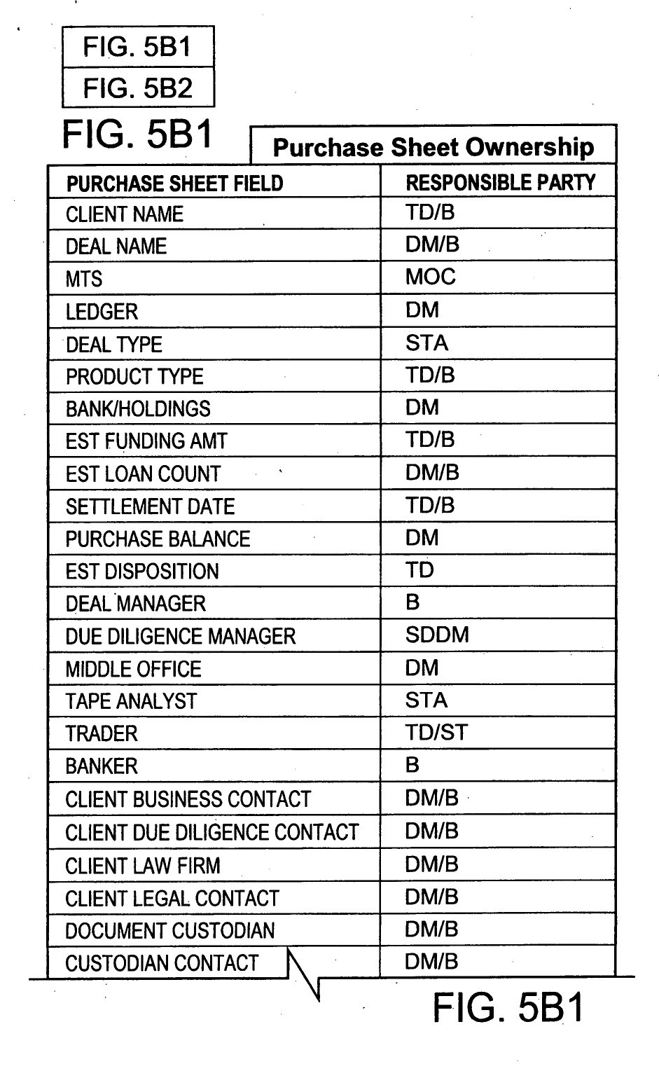

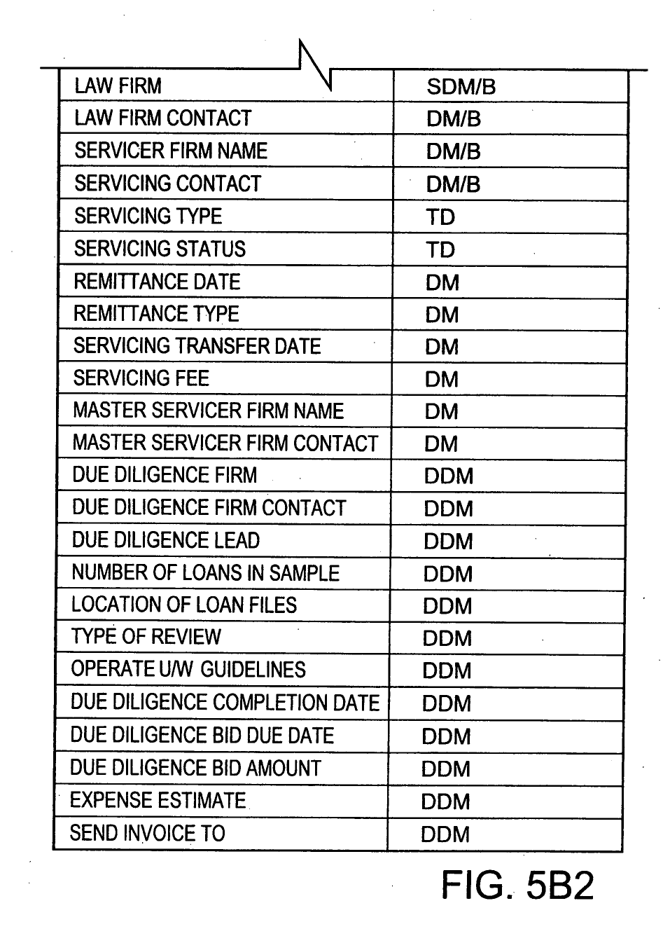

Transaction management system 50, in one embodiment, provides a “deal home page” interface including links to various documents, reports, and functionality associated with the system of the present invention. As FIG. 4 shows, a deal home page may include a link to a purchase sheet to authorized internal and external users. As FIG. 5A shows, a purchase sheet provides a transaction-level overview of deal parameters and timelines, such as personnel assigned to the transaction, closing date, etc. As described more fully below, users associated with different user roles have certain responsibilities to fill in selected fields of the purchase sheet. FIGS. 5B1-5B2 illustrate a matrix providing the purchase sheet responsibilities for respective users according to an embodiment of the present invention. In one form, transaction management system 50 is operative to tailor the purchase sheet interface to a particular user by limiting read and/or write access to selected fields of the purchase sheet according to the privileges defined in the user role associated with the user.

In addition, transaction management system 50 is further operative to limit access to functionality associated with the system of the present invention. For example, transaction management system 50 limits access to external services, such as automated underwriting services to users associated with tape analyst user roles. In one embodiment, such access is controlled by omitting, or rendering inactive, links to pages or other interfaces associated with such services in pages presented to unauthorized users.

A.1.b. Administrative Functionality and User Groups

Administrator interface 90 facilitates maintenance and configuration of the system according to the present invention. As discussed above, in one embodiment, system settings/user account database 51 stores system setting and configuration data, as well as user accounts defining contact information, authentication data, access privileges, etc. associated with users of the system. In one embodiment, administrator interface includes the following capabilities:

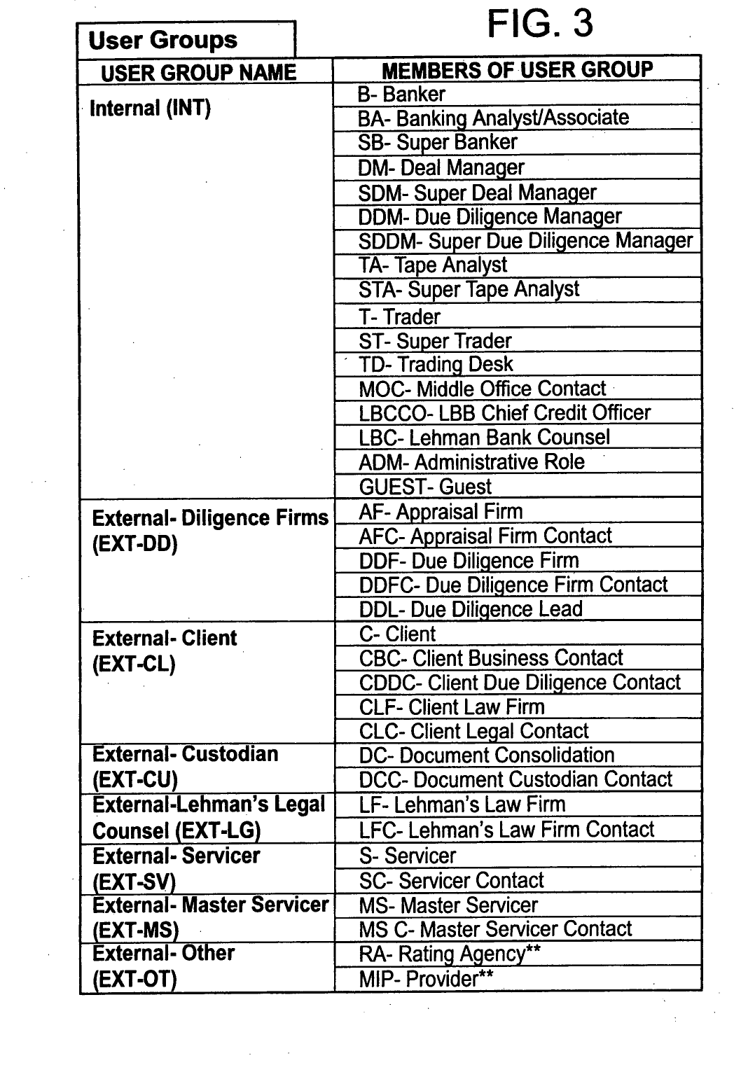

Administrator interface 90 allows privileged users to create new user accounts as well as modify data associated with existing user accounts. In one embodiment, each user account is associated with a user group and a user role. A user role maps to a set of access privileges (e.g., read and/or write access to a specific deal or all deals, access to create/modify user accounts, etc.) to the files, data, and/or services available on transaction management system 50 and loan tracking system 70. In one embodiment, user groups are arranged both according to functional considerations, as well as whether the group is internal or external to the investment bank. See FIG. 3. For example, at the top level, user groups are divided into internal user groups and external user groups. External user groups include due diligence firms, client banks, legal counsel, etc. In addition, each user group includes at least one user role.

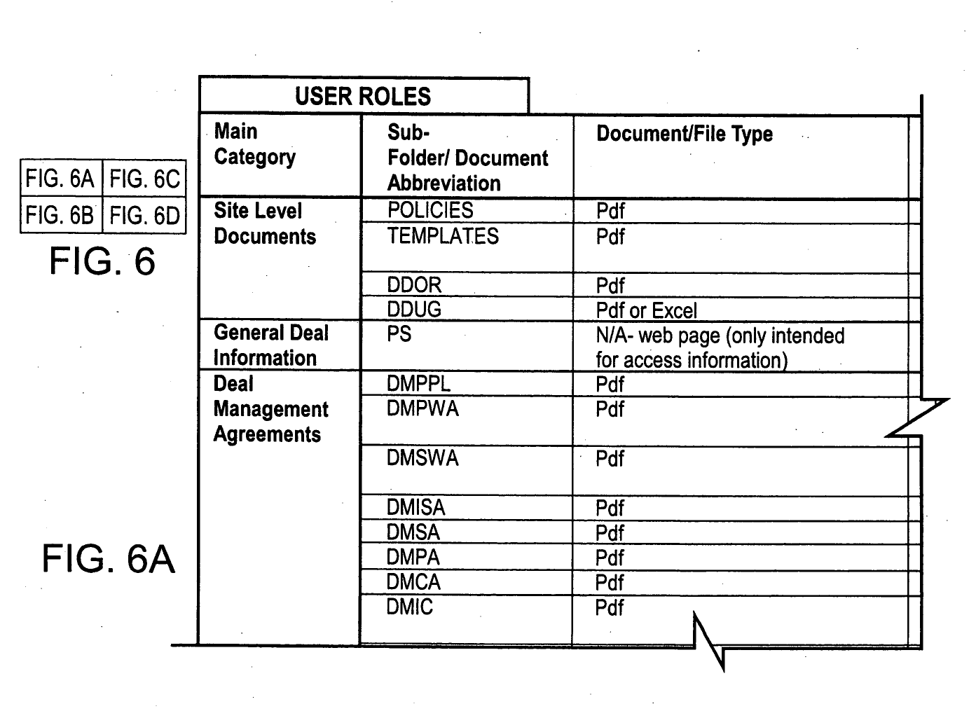

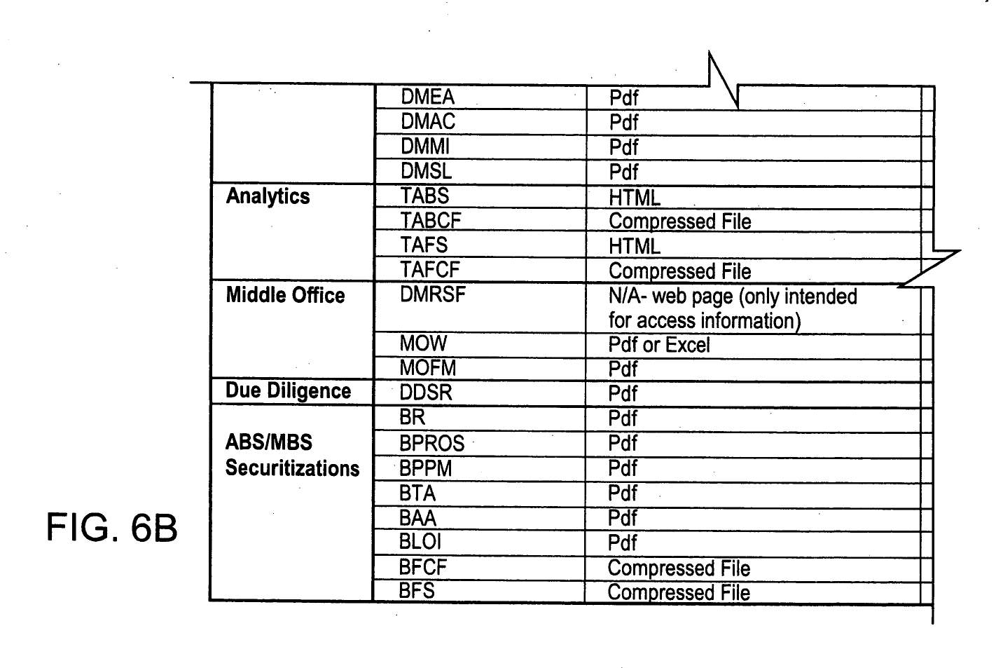

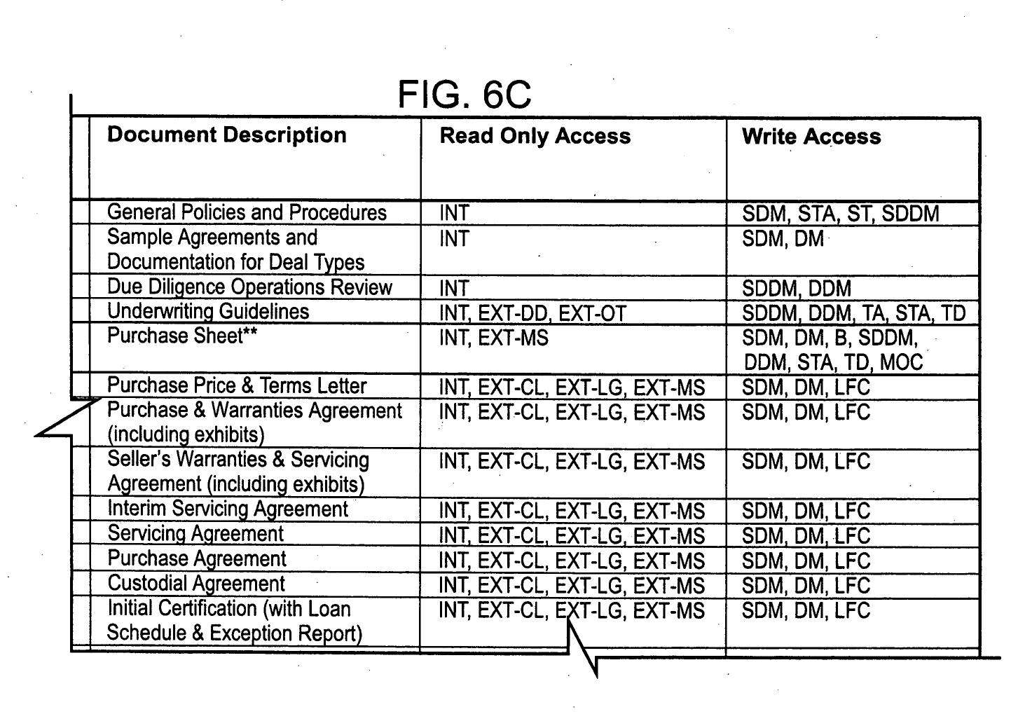

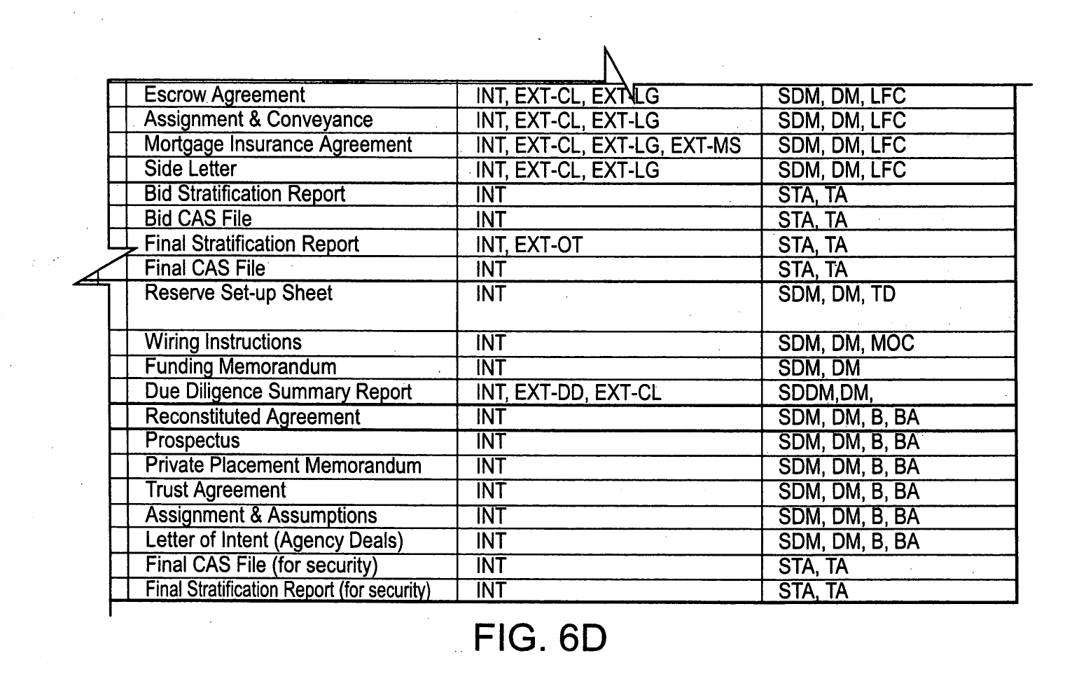

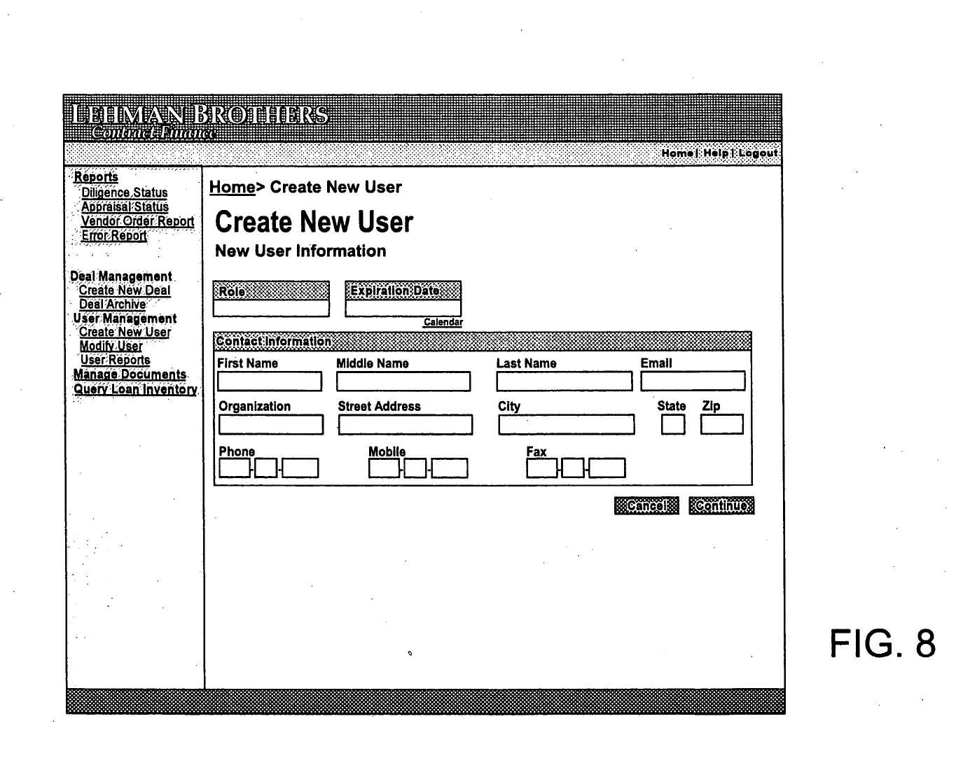

In one embodiment, the systems administrator, super deal manager, super tape analyst, super due diligence manager, super banker and super trader are able to add new user accounts, grant appropriate levels of access and modify existing user accounts. However, only the systems administrator has the authority to create and modify user accounts for new super users (i.e., the super deal manager, super tape analyst, super due diligence manager, super trader, and super banker). In one embodiment, the following data elements are required in order to establish a new user: first name, last name, user role, phone number, firm name, and email address. As FIG. 8 shows, a drop-down menu facilitates association of a user role to the newly created account. For didactic purposes, FIGS. 3 and 6 illustrate an exemplary set of user roles and access privileges to documents stored in document management system 60. In one embodiment, the creation of an external user account further requires an expiration date beyond which the user will no longer have access to the system. In addition, transaction management system 50 also supports the following data elements when setting up a new user: middle initial, cellular phone number, fax number, business city, business state, business zip code. In one embodiment, the first time a user accesses transaction management system 50, after being contacted with password information, he is required to change the password associated with the user account. In one form, transaction management system 50 detects that the user is a first-time user, and redirects them to a page-based interface facilitating the changing of passwords.

According to the operating procedures of an investment bank, certain user roles may require the appointment of a secondary contact or designee. For example and in one embodiment, an investment bank may require that user accounts associated with the following user roles have a designee: the super tape analyst, super due diligence manager, super deal manager, super trader, client business contact, client due diligence contact, banker, servicer contact, document custodian contact, master servicer contact, middle office contact. If the user role requires, a page-based interface that asks for the designee contact information follows the user contact information page. In one embodiment, the page includes a drop down menu that contains all existing users within the user's group. From this menu, a designee can be selected. In one form, the user creation interface includes a check box to optionally give all permissions of the primary user to the designee. In the event that at permissions are not granted, the designee will only receive duplicate email notifications. In addition, transaction management system 50 generates reports of users by user group and user role to allow the systems administrator and/or other super users the ability to verify that access levels and privileges, as well as expiration dates, are correct.

Transaction management system 50, as discussed above, is operative to enforce access privileges and permissions associated with various user roles. In one form, the access privileges associated with each user role are coded into the web server or other functionality associated with transaction management system 50 to allow the dynamic display of content for specific user roles. Specifically and in one embodiment, transaction management system 50 validates that the user issuing a request for a page has requisite access rights before serving the requested page. Various schemes are possible to allow transaction management system 50 to associate a request with a particular user and, therefore, a user role, including the use of browser cookies and the like.

Administrator interface 90 can include other administrative capabilities. For example, in one embodiment, the systems administrator is tasked with maintaining an accurate set of drop-down menus associated with the purchase sheet interface. For example, as various users terminate employment at the investment bank, the systems administrator must delete them from any drop-down menus provided by the purchase sheet interface. In one embodiment, other “super” users who are able to enter data into a field associated with the purchase sheet interface are also able to modify the list of data elements contained in the field. For example, the super tape analyst is able to modify the list of tape analysts in the drop-down menu facilitating their selection. In one embodiment, administrator interface 90 automatically deletes users from drop-down menus when their respective user accounts are deleted from the system.

A.1.c. Presentation Engine

Presentation engine 57 facilitates the generation of reports related to financial transactions. Presentation engine 57 includes various templates each associated with a report type corresponding to various components of a financial transaction. Report types include summary reports characterizing a group or pool of loans and loan-level reports including data associated with individual loans. In response to a request for a particular report, presentation engine 57 renders loan data from loan tracking system 70 and formats the loan data according to a predefined template corresponding to the requested report. In one embodiment, presentation engine 57 accesses data from loan tracking system 70 and dynamically generates sections of reports as users click on various links presented in page-based interfaces associated with the report. In one embodiment, however, presentation engine 57 is operative to generate reports and store them in document management system 60. In one embodiment, presentation engine 57, in response to a request for a report, generates and transmits an XML request to network services gateway 55 which extracts requisite loan data from loan tracking system 70 and transmits an XML response. Presentation engine 57 then generates the report using the data in the XML response.

A.1.d. Notification Module

As discussed in more detail below, the detection of events and milestones in a work flow trigger notification module 53 to transmit messages to appropriate users notifying them of the event and/or any required actions or tasks. In one embodiment, each event has associated therewith at least one user role and a predefined message or message template. When notification module 53 is invoked to transmit a notification, it accesses deal level data to determine the users corresponding to the user roles associated with the specific event. In one embodiment, notification module 53 transmits email notifications to users. In one embodiment, email notifications may include links to documents and files stored in document management system 60, or to web pages associated with a transaction. Accordingly, when a user receives a notification, she need only click on the link in the message (and authenticate herself, if not already logged in to the system) to access documents, reports or other data associated with the notification. In addition, notification module 53 may also support other types of notifications, such as simple text messaging on wireless devices, instant messaging, and voice mail messaging.

A.2. Document Management System

Document management system 60 provides electronic filing and management of documents, reports and other files, as well as file and document query tools. In one embodiment, document management system 60 implements a folder-based filing structure where, at the root level, a deal folder represents a transaction. Each deal folder includes sub-folders representing various tasks, elements, and/or stages associated with a transaction. As discussed in more detail below, individual users upload documents into appropriate sub-folders according to their respective roles in the transaction.

Document management system 60 includes basic file navigation features such as folder navigation and filename searches. In one embodiment, document management system imposes a standard folder naming convention to facilitate navigation and searching. For example, the naming convention for a whole loan purchase or sale transaction can comprise a deal name and an internal code generated upon creation of the transaction, allowing for searches by deal name and/or internal code. In addition, document management system 60 also supports searches by key word, document type, modification date, and any other available file attribute. In addition, document management system 60 supports URL-based access to files and documents stored therein, allowing users to email hypertext links to files and documents.

Document management system 60 also maintains other folders associated with documents and files beyond the transaction level. For example, document management system 60 includes a general folder to store documents pertaining to the general conduct of financial transactions and/or maintenance and use of the system, including business policy manuals, system training and tutorial documents, general underwriting guidelines, etc. Document management system 60 further maintains folders associated with documents that apply to more than one transaction or deal, such as mortgage insurance policy associated with several loans across one or more deals. Document management system 60 also maintains general and deal-level folders for event logs and calendars. For example, event logs allow individual users to track timelines and manage work flows across deals. Calendars allow individual users to manage and keep others aware of events and deadlines associated with a single transaction.

Document management system 60 further includes a loan level document linkage tool or interface that links or associates such documents to individual loans stored in loan tracking system 70. In one embodiment, the tool is operative to populate reserved fields in corresponding individual loan records maintained by loan tracking system 70 with pointers to the document stored in document management system 60.

In one embodiment, document management system 60 supports one or more folder templates associated with a transaction type. Specifically and in one embodiment, when a new deal is created, document management system 60 defaults to a standard organization of sub-folders within the root-level deal folder. In one embodiment, main sub-folders organize a transaction into the following categories: General Deal Information, Deal Management Agreements, Analytics, Middle Office, Due Diligence, and Securitizations. Each main sub-folder includes default document level folders for each standard document associated with the transaction. See FIGS. 6A-6D. Each document level folder is named according to a standardized document name or code (e.g., DMPPL), allowing users to query by document type as well as by deal name and internal code. Additional sub-folders can be added to an instance of a deal folder to accommodate non-standard or additional document types.

Document management system 60 is also operative to enforce access privileges associated with different user groups and roles, such as providing read and/or write access to specific deal folders or sub-folders thereof to authenticated and privileged users. For example, different user groups have access to different types of documents. The user group or user role determines which documents are visible when a user associated with that user group or role accesses document management system 60. For example, an external user such as a client bank is able to access deal folders and sub-folders directly associated with it. Moreover, as to each deal folder, the client bank may only review negotiated transaction documents, but not internal reports and analytics. FIGS. 6A-6D sets forth an exemplary set of user groups and their respective levels of access to specific documents. Furthermore, document management system 60 is further operative to enforce access and modification privileges associated with user roles within each user group to deal-level, main sub-folders and document level folders. For example, within the Internal user group, a Tape Analyst is able to read but not edit the Deal Management Purchase Price and Terms Letter (DMPPL), whereas a deal manager is able to both read and edit the document. As discussed above, administrator interface 90 allows for the configuration of user groups and user roles as required to enable each user's participation and enforce appropriate levels of access.

Document management system 60 also manages and limits the number of stored revisions of an active document. In one embodiment, the default number of revisions for an active document is five versions. Document management system 60 automatically purges the oldest version above the default threshold unless an administrator (or other user) with appropriate access rights changes the setting.

A.3. Loan Tracking System

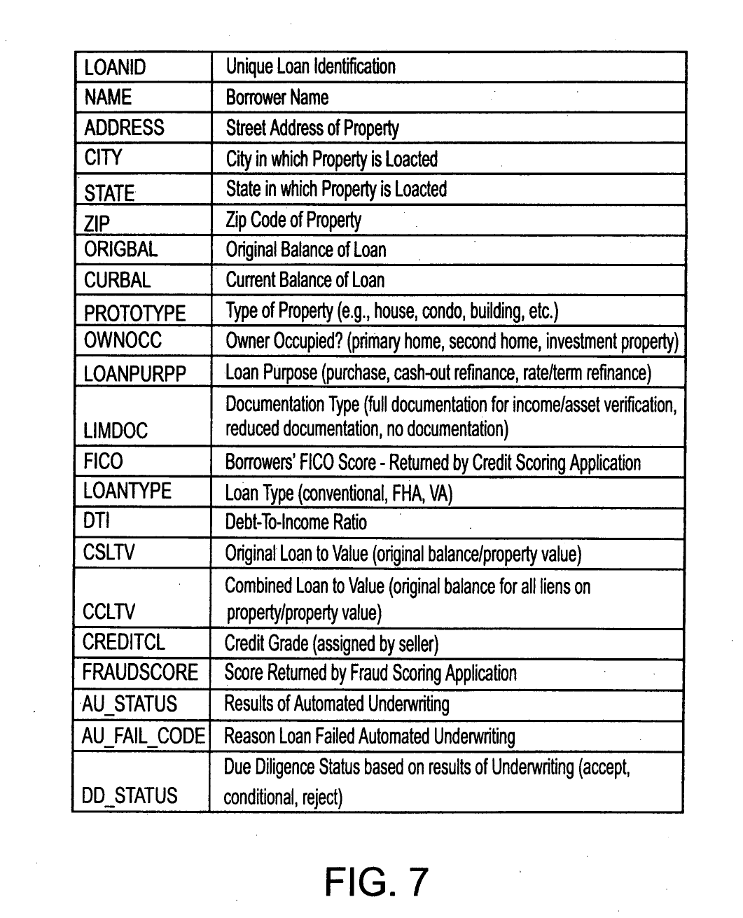

Loan tracking system 70 maintains data associated with transactions and individual loans. In one embodiment, the data stored in loan tracking system 70 is arranged in a hierarchical structure based on each transaction. Each transaction record has the following attributes: a transaction identifier (e.g., deal name+internal code), a pointer to a purchase sheet record, a pointer to a sample record, and a loan array containing a list of pointers to individual loan records. Other attributes of a transaction record include a deal milestone field storing information characterizing the stage associated with a particular deal, such as “Bid,” “Potential Purchase,” “Inactive-Bid Lost,” etc. (see Section II.A., below). Other attributes may include a transaction event field indicating transaction events and associated time stamps. A purchase sheet record includes attributes defining the parameters associated with the transaction, such as closing date, the client bank, etc. The attributes associated with a sample record include pointers to loan records corresponding to selected loans and the services performed on the sample. A loan record includes data fields defining parameters associated with a loan. FIG. 7 provides the data fields for each loan record in loan tracking system 70 according to one embodiment of the present invention.

Transaction management system 50 uses loan categories to track the current status of loans in the investment bank's inventory. In one form, each loan or pool of loans, at any one time, has one of the following categories associated therewith: null, Bid, Potential Purchase, Owned Asset, Potential Securitization, Securitized Asset, Potential Sale, Sold Asset, Inactive-Never Purchased, Inactive-Liquidated, Inactive-PaidOff, Inactive-Bid Lost, Third Party Asset, or Warehouse Financing Asset. In one embodiment, work flow management engine 52 accesses and modifies the category fields and other milestone attributes associated with a deal or individual loan(s) to maintain the transaction work flow and, therefore, track the status of the transaction and individual loans associated with a transaction.

In addition, loan tracking system 70 maintains static and time series data for active loans associated with the portfolio of currently held loans. Tracking of time series data such as payment history allow for refinements to loan analysis, such as risk and pricing processes. It also allows for monitoring the performance of the loan portfolio to mitigate risk and help direct future business efforts. Loan tracking system 70 also uses categories to track loans subsequent to purchase. For example, a loan or group of loans could securitized and change from “owned asset” to “securitized asset, be paid off and change to “Inactive—Paid Off”, and so on.

A.4. Network Services Gateway

Network services gateway 55 includes web services network functionality to process and route service requests and responses over a computer network. In one embodiment, network services gateway 55 implements a communications model based on requests and responses. Network services gateway 55 generates and transmits a service request to an external vendor, such as fraud check system 30, which receives the request, executes operations on data associated with the request, and returns a response. Network services gateway 55, in one embodiment, further includes other web services functionality such as togging of service requests and responses allowing for tracking of costs and usage of services.

Network services gateway 55 relies on secure HTTP communications and XML technologies for request and response formats. In one embodiment, network services gateway 55 maintains Document Type Definitions (DTDS) and/or schemas that define the format of the XML request and XML response. Request and response DTDs include a message type, transaction identification, vendor/service identification, and an application identification. Message types corresponding to service requests include synchronous order, asynchronous order, cancel order, pickup request, status request. Message types corresponding to service responses include payload (the results of a successful order), acknowledgement (successful receipt of an asynchronous request), or status (response to status request). Network services gateway 55, in one embodiment, is operative to validate responses from external services against the Document Type Definitions.

Requests can be synchronous or asynchronous. A synchronous request is used for immediate fulfillment as follows: Network services gateway 55 opens a secure HTTP connection with the external service node and transmits a request via an HTTP POST. The connection remains open until a response is returned. Asynchronous requests for delayed fulfillment generally proceed as follows: Network services gateway 55 opens a secure connection with an external service node and transmits a request via an HTTP POST. Upon acknowledgement of the POST, network services gateway 55 closes the connection. After a scheduled amount of time, network services gateway 55 establishes another secure connection with the external service node and transmits a request including a transaction identifier associated with the original request. The connection remains open until the external service node returns a response. For a follow up request the payload “order” will be returned or the status such as pending, error, fulfilled etc. Any suitable communications protocols, such as HTTPS or SSL, and data formats can be used.

Network services gateway 55 allows for efficient integration of external and internal services to the present invention. In one embodiment, network services gateway 55 is operative to extract and import data from loan tracking system 70 in response to service action requests and responses. Network services gateway 55 works with a layer that maps data from the internal representation of loan tracking system 70 to an XML request formatted according to predefined document type definitions, as appropriate for the requested service. This layer further allows for mapping of XML responses to the internal representation of loan tracking system 70. Accordingly, and in one embodiment, network services gateway 55 is operative to receive a request for a service associated with at least one loan in loan tracking system 70, export the data from loan tracking system 70, and transmit an XML request to the identified service application.

B. External Services and Enterprises

As FIG. 1 illustrates, the system of the present invention operates in connection with external systems over an open computer network via network services gateway 55. In addition, as discussed above, outside enterprises with responsibilities or roles in a particular transaction or group of transactions may be granted access to files and other documents available via transaction management system 50.

B.1. Fraud Check System

Fraud check system 30 maintains a fraud scoring application service available over computer network 20. In one embodiment, fraud check system 30 is operative to receive a service action request including one or more loans and associated data fields and return a response including a score or rating indicating a level of confidence as to data integrity and quality control. In one embodiment, the application includes a set of quality control and data integrity filters that analyze a variety of loan data fields, retrieve data from database sources and score data inconsistencies and variances based on a set of rules derived from experiences with prior fraud cases. Fraud check system 30 is also operative to detect data integrity input errors and misrepresentations, validating the integrity of FICO, Desktop Underwriter, Loan Prospector, Sub-prime Credit Grades or other automated credit and underwriting scores.

B.2. Credit Report Data Site

Credit report data site 40, in one embodiment, is run by a credit reporting bureau, such as Equifax®, Transunion®, or Experian®. In another embodiment, credit report data site 40 includes functionality for retrieving and merging credit report data from a plurality of credit reporting bureaus. As with fraud check system 30, credit report data site 40 offers a web-based application service that receives borrower information and returns credit history data and credit scores, such as a FICO score, in response.

B.3. Automated Underwriting System

Automated underwriting system 35 hosts a XML-based underwriting application service that segregates a pool of loans into predefined categories based on a set of underwriting guidelines implemented by a rule set. In one embodiment, the underwriting service is operative to segregate a pool of loans based on predefined underwriting guidelines into several categories, such as Prime and Sub-Prime. In one embodiment, the underwriting service also offers functionality allowing for generation of pricing information for each loan in the submitted pool. In one embodiment, the rule set implemented by automated underwriting system 35 may be extended to incorporate pricing and/or risk models allowing for generation of loan-level pricing and risk data.

B.4. Other External Enterprises and Services

As discussed above, other external enterprises and services may further include client bank 81, demographic information system 82, document custodian 83, outside legal counsel 84, due diligence firm 85, and appraisal firm 86. Client bank 81 and outside legal counsel 84, in a typical scenario, include users associated with user accounts. Such users are given passwords enabling access to documents and data via transaction management system 50, as described above. Due diligence firm 85 and appraisal firm 86, in one embodiment, offer application services available over computer network 20 in a similar manner to the external services described above.

II. Work Flows

The following illustrates the operation and work flows associated with embodiments of the present invention. As discussed below, the present invention facilitates and supports management, due diligence, analysis and other tasks associated with financial transactions. In one embodiment, transaction management system 50 facilitates management and other tasks associated with whole loan transactions as follows.

A. Whole Loan Buying

On the purchasing side, whole loan transactions typically involve three main areas: trading, deal management and due diligence. In addition, whole loan transactions require the coordinated effort of several departments and users within each department to accomplish all required tasks. Transaction management system 50, in one embodiment, includes functionality that facilitates coordination of tasks and users. Transaction management system 50 also includes functionality that supports various users' roles or responsibilities in each transaction.

A.1. Trading

A. 1.a. Creating New Deal Folder

A workflow for a potential whole loan purchase transaction begins when a trader notifies the super tape analyst of a new bid transaction, for example, by phone or email. In one form, the trader transmits to the super tape analyst the loan data file supplied by the client/originator bank as an email attachment. The super tape analyst accesses transaction management system 50 to create a new transaction and configure corresponding deal folders. In one embodiment, the super tape analyst specifies a deal name and a product type, such as Sub-Prime, Prime, etc. In one embodiment, the super tape analyst names the transaction according to the client/originator bank and the current date. In one embodiment, the interface provided by transaction management system 50 facilitates construction of the transaction name with a pull-down menu of client originator bank names. To construct the deal name, the super tape analyst selects the appropriate name. To construct the deal name, transaction management system 50 adds the current date to the selected name. In the event that multiple bids corresponding to the same client/originator bank, transaction management system 50 adds letters beginning with “A” as a suffix to the transaction name. The name acts as an identifier for the transaction throughout the bidding process.

After the super tape analyst creates the active deal folder, she assigns the bid to a specific tape analyst. In one embodiment, the purchase sheet interface provided by transaction management system 50 includes a pull-down menu 102 facilitating selection of available tape analysts (see FIG. 5A). Upon verification that the assignment is complete, work flow management engine 52 triggers notification module 53 to generate and transmit a notification to the newly-assigned tape analyst. In one embodiment, the notification is an email message stating: “A new bid package has been assigned to you. Please check the Transaction management System for details.” In one embodiment, the notification includes a link to the deal home page corresponding to the transaction. In other embodiments, transaction management system 50 can generate a voice mail, a text message for a wireless phone or other device, etc.

A.1.b. Generation of Loan-Level and Summary Reports

The assigned tape analyst logs into to transaction management system 50 and accesses the deal home page. In one embodiment, the deal home page includes a link to the loan data file supplied by the client bank. In another embodiment, the super tape analyst emails the loan data file to the tape analyst. After the deal is won, the loan data file and stratification reports will be uploaded into the document management system so the deal team can easily access up to date reports. The tape analyst, using tape analyst module 58, imports the loan data into loan tracking system 70. In one embodiment, the loan data file is imported into a Collateral Analysis System (CAS) system to generate reports. Once imported, the CAS file is exported, converted into XML format and imported into loan tracking system 70. Tape analyst module 58 includes functionality that maps loan data files to the internal representation of the data format in loan tracking system 70. In another embodiment, tape analyst module 58 translates the loan data file into an XML document and transmits it to network services gateway 55, which populates loan tracking system 70 with the loan data. In one embodiment, transaction management system 50 validates the upload for completeness against a predetermined set of data points and provides confirmation of a successful upload to the tape analyst. In the event of an error due to missing or invalid data, transaction management system 50 generates a error message that refers to the specific record and details about the problem. The tape analyst corrects the identified problems and uploads the documents. The tape analyst may also upload any underwriting guidelines, if available, into document management system 60. Upon successful uploading of loan-level data into loan tracking system 70, workflow management module 52 changes transaction and loan categories from null to “Bid.” After discussions with the trader assigned to the transaction, the tape analyst selects which underwriting operations or services to perform on the loan data.

The tape analyst accesses the loan data to generate a loan-level and summary reports using functionality described below. Specifically, the tape analyst generates summary reports, including a tape analyst bid stratification report using standard analytics packages and high risk report enabled by an embodiment of the present invention. Specifically, the tape analyst uses analytics software, such as Collateral Analysis System software (CAS), to generate a tape analytics bid stratification report and uploads the report into the Analytics sub-folder associated with the transaction in document management system 60. In one embodiment, the bid stratification report includes a break down of the loans in the current pool as to several factors, including but not limited to current outstanding balance, interest rate, FICO score, remaining term, etc. Using tape analyst module 58, the tape analyst also generates high risk reports enabled by embodiments of the present invention and uploads them into document management system 60.

High Risk Reports

Tape analyst module 58 facilitates generation of high risk reports as detailed below. The tape analyst generates high risk reports detailing the risk profile of the loan pool to allow the trader to assess the value of the pool prior to placing a bid for purchase of the loans. High risk reports also allow for identification of unacceptable loans prior to placing a bid. Accordingly, a trader may submit a bid to the client bank indicating which loans are excluded. In one embodiment, the high risk reports comprise data from two sources: internal query results from loan tracking system 70 and outside-vendor query results.

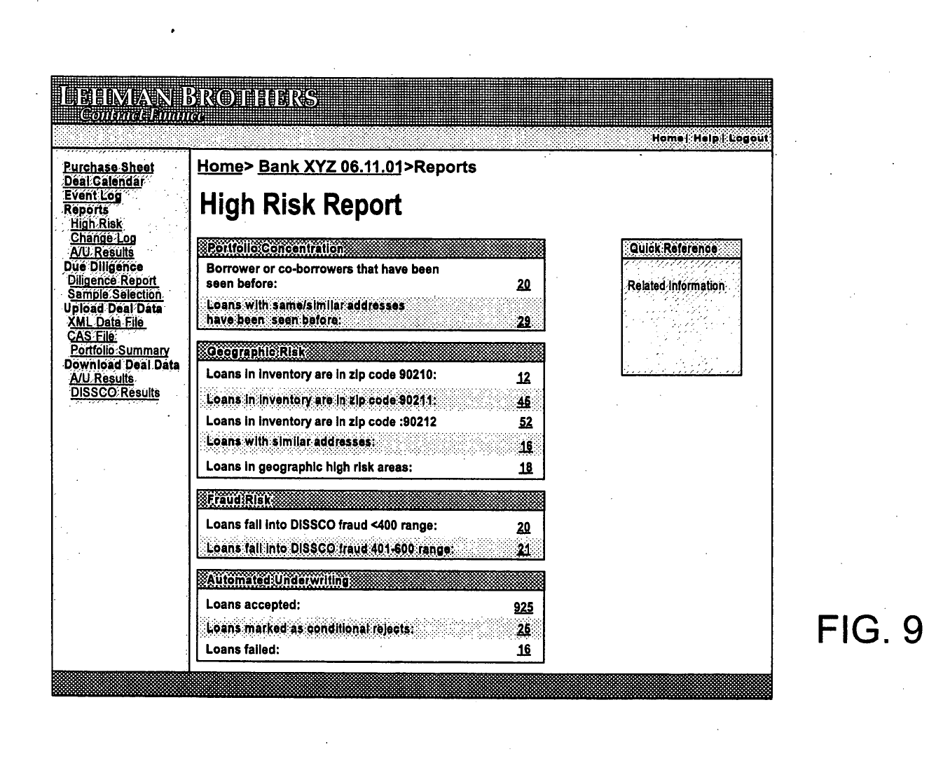

The tape analyst, in one embodiment, initiates a high risk report query by running the loan data against an internal query service including the active and inactive loans in loan tracking system 70. FIG. 9 illustrates a high risk report interface illustrating the selection of available services for a high risk report. High risk reports facilitate an assessment of the risk profile associated with the current loan pool against the portfolio of loans maintained by loan tracking system 70. High risk reports also take advantage of data associated with both active and inactive loans to assess the risk profile of the loan pool. FIG. 9 provides a summary level view of a high risk report. In one embodiment, the query service reports on the following items:

Borrower Concentration: The query service cross-references the current loan pool against the active and inactive loans in loan tracking system 70 to determine whether any borrower identified in the current loan pool is a borrower associated with an active or inactive loan. The query service primarily uses the borrower's social security number to perform the check and/or the borrower's name, if the social security number is unavailable.

Co-Borrower Concentration: The query service also performs the same action with respect to any co-borrowers associated with the current loan pool.

Address Concentration: The query service also scans the property address for each loan in the pool against loans in loan tracking system 70 for matching addresses. The High Risk Report identifies any loans in loan tracking system 70 with matching property addresses. In one form, the query service narrows the search for a matching address by scanning first for matching zip codes and then for similar street addresses, ignoring street types. For instance and in one embodiment, “123 Meadow Road” and “301 Meadow Court” are considered similar. In addition, sub-string matches are also considered similar addresses.

Zip Code Concentration: To assess how the acquisition of the loan pool affects the geographic concentration of the investment bank's portfolio, the query service references the zip codes corresponding to the properties covered by the loan pool against the loans in loan tracking system 70 whose properties are located in the same zip code. In one embodiment, the high risk report contains the top five zip codes within the pool of loans being analyzed based on the percentage of the aggregate loan balance.

High Risk Area Concentration: The query service also scans the zip codes corresponding to the loan pool against a list of “high risk area” zip codes maintained by loan tracking system 70. The high risk report, in one embodiment, identifies the number of properties located in high risk areas.

Fraud Check Score: The High Risk Report also displays a fraud check score, if any, for each loan in the current pool. In one embodiment, loan data is transmitted to a web-based fraud check service which returns loan level fraud detection scores based on the vendor's internal model and fraud check scores are returned (see below).

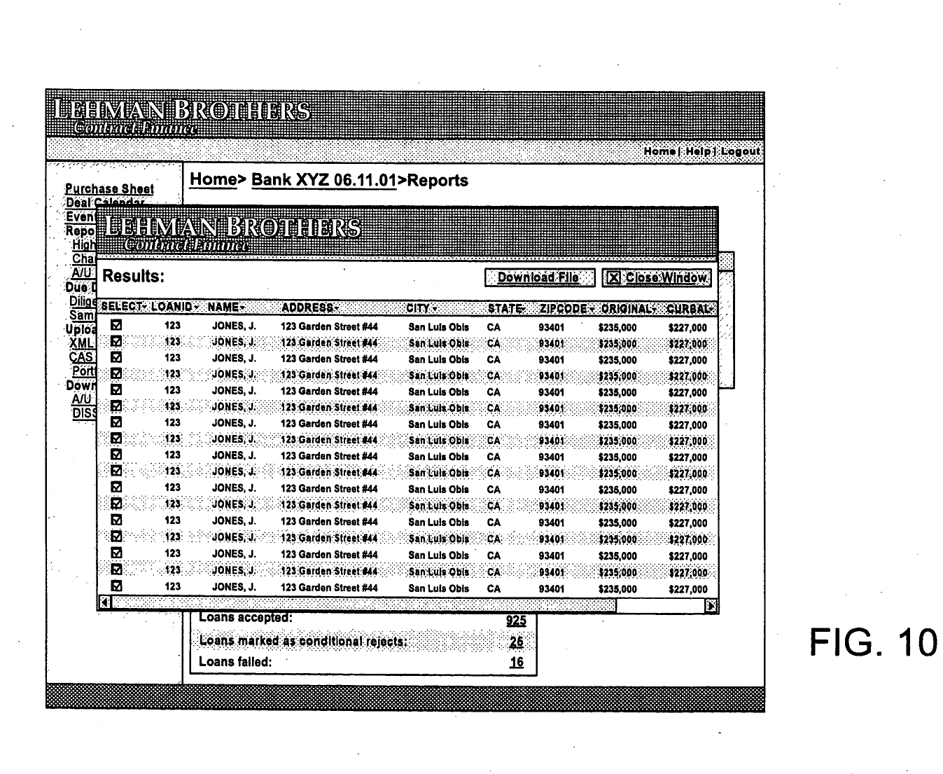

To the extent that data required for a specific check is missing from the loan data imported into loan tracking system 70, tape analyst module 58 returns null values in appropriate fields of the high risk report. In addition, a loan in loan tracking system 70 that has insufficient information to provide results is omitted from the query universe (e.g., a blank address for a prior loan in loan tracking system 70 should not match loan in the current pool also having a blank address field). In one embodiment, the high risk report interface includes links associated with each report category, which, when clicked, provides loan-level data corresponding to the loans in the category. (See FIG. 10).

When all operations and services required for generation of the high risk report are completed and associated data stored in loan tracking system 70, notification module 53 notifies the tape analyst and trader by email. In one embodiment, transaction management system 50 makes the high risk report available to various users having access privileges. In one form, the deal home page includes a link to the high risk report. The high risk report provides results both on a summary and individual loan level (see FIGS. 9 and 10). In one embodiment, the corresponding deal home page contains a link to the high risk report. In one embodiment, presentation engine 57, when a user clicks on the appropriate link, dynamically generates the high risk report by extracting requisite data stored in loan tracking system 70, processing it and creating the high risk report according to a predefined template. In another embodiment, presentation engine 57 creates the report and stores a version of it in document management system 60.

In one embodiment, a high risk report may include data obtained from external application services, such as automated underwriting and fraud check services. In one form, tape analyst module 58 includes functionality and interfaces that integrate external application services. In one embodiment, tape analyst module 58 waits for completion of the operations associated with external services before notifying users associated with the deal.

A.1.b.1. Fraud Check Interface

Tape analyst module 58 of transaction management system 50 facilitates interaction with a fraud scoring application. In one embodiment, the fraud scoring application is a web service available at fraud check system 30 accessible over computer network 20. Tape analyst module 58 and network services gateway 55 facilitate generation of a fraud scoring request as an XML document, including required loan level data stored in loan tracking system 70. In one embodiment, tape analyst module 58 composes a fraud check request, including identifications of the loans associated with the request, and transmits it to network services gateway 55. Network services gateway 55 extracts required loan data from loan tracking system 70, composes an XML request and routes it to fraud check system 30. In another embodiment, tape analyst module 58 is operative to extract required loan data, compose the XML request and transmit it to network services gateway 55 for routing to fraud check system 30. In one form, tape analyst module 58 provides the tape analyst confirmation of a successful upload. In the event that an error occurs due to missing or invalid data, the tape analyst is notified and required to correct identified problems and re-submit the request. The fraud check request can be a synchronous request or an asynchronous request.

The response to the fraud check request, in one embodiment, is also an XML document. Network services gateway 55 receives the XML response and stores the loan level fraud scores and associated data in loan tracking system 70, making it available for inclusion in the high risk report generated by tape analyst module 58.

A.1.b.2. Automated Underwriting Interface

Tape analyst module 58 also facilitates generating service requests to automated underwriting system 35 and supporting services, such as credit report data site 40.

A.1.b.2.(a) Credit Report Pull

In one embodiment, the tape analyst initiates the automated underwriting process by requesting a credit report for each borrower in the loan pool from credit report data site 40. Using tape analyst module 58, the tape analyst selects all or a subset of the loans in the pool and requests a credit report for each borrower associated with the selected loans. Network services gateway 55 receives the request, pulls the required loan data from loan tracking system 70, composes a credit report request, and transmits it to credit report data site 40. In one embodiment, the credit report request is an XML document including the loan data required to process the request. In one embodiment, the tape analyst receives confirmation of a successful upload to credit report data site 40. Missing or invalid data in the credit report request generates an error message identifying specific problems (e.g., missing or invalid data) associated with the request.

Credit report data site 40 receives and processes the request. Credit report data site 40, in one embodiment, returns FICO score data for each borrower identified in the credit report request in an XML response. Network services gateway 55 receives the XML response and populates appropriate data fields in loan tracking system 70. Tape analyst module 58 allows the tape analyst to view the credit report data in association with the corresponding loans stored in loan tracking system 70. Primarily, however, the FICO score data are used as inputs in requests for automated underwriting services and is generally available for use in loan level queries and the generation of reports using presentation engine 57.

A.1.b.2(b) Initiation of Automated Underwriting Service

Once the credit report data pull is complete and the data stored in loan tracking system 70, the automated underwriting process is initiated. In one embodiment, the automated underwriting process is explicitly initiated by the tape analyst, using tape analyst module 58, upon receipt of a notification that the credit report data pull is complete. In another embodiment, workflow management engine 52 automatically initiates the automated underwriting process, upon notification from network service gateway 55 that the credit report data pull is complete.

To initiate the automated underwriting process, network service gateway 55 composes an XML request, including the credit report data obtained from credit report data site 40, and transmits the request to automated underwriting system 35. Automated underwriting system 35 process the request and returns a response including a report in XML format. Network service gateway 55 receives the response, validates it against the Document Type Definition associated with the response, and imports the report data into loan tracking system 70. Network service gateway 55 reports the successful receipt of the underwriting data to workflow management engine 52.

A.1.b.3. Generation of High Risk Report

After responses from the requested external services are received and appropriate data imported into loan tracking system 70, work flow management engine 52 triggers the internal query services discussed above. Upon completion of the internal services, work flow management engine 52 then triggers notification module 53 to notify the tape analyst that all requested services are complete. The tape analyst accesses transaction management system 50 and clicks on appropriate links in the interface to generate the high risk report using presentation engine 57. In another embodiment, work flow management engine 52 triggers presentation module 57 to automatically generate high risk reports including summary and loan-level underwriting components and store them in deal level folders maintained by document management system 60.

Presentation engine 57 allows for the generation of summary and loan level reports detailing the results of the automated underwriting process to assist the trader and the tape analyst to price the loan pool. Each summary underwriting report, in one embodiment, lists the applicable underwriting categories described above. For each category, the underwriting report contains the following information: 1) the number of loans in the category, 2) aggregate outstanding principal balance, and 3) data allowing for assessment of aggregate relative asset value. Presentation engine 57 also facilitates generation of a loan-level underwriting reports containing economic and non-economic information, as well as the results of the automated underwriting service (e.g., category segregation and/or loan pricing data).

A.1.c. Placing Bid

Once the trader has reviewed and checked the loan pool summary, high risk and automated, underwriting reports, (s)he places a bid for purchase of the loan pool, typically by contacting the client originator bank by telephone or email. The client/originator bank evaluates the bids and notifies the winner.

In one embodiment, transaction management system 50 facilitates recordation of the results of a bid and deployment of resources to the transaction if a bid is accepted. For example, in the event that the investment bank's bid is not accepted, the trader will access transaction management system 50 and input the client/originator bank's response and a reason, if any, for rejecting the bid on the deal home page interface. In one embodiment, the interface presented to the trader includes a set of predefined reasons, one of which the trader may check: 1) pricing, 2) originator bank has no experience with investment bank, 3) originator bank not comfortable with investment bank's documentation, 4) originator bank had bad experience with investment bank, or 5) missed bid deadline. In one embodiment, the interface further includes a text box allowing for entry of free-form comments. When the trader selects a reason, transaction management system 50 changes the deal status to “Inactive” and the loan category from “Bid” to “Inactive-Bid Lost.”

In addition, all the loan records corresponding to the loan pool in loan tracking system are flagged as “Inactive.” Inactive loans stored in loan tracking system 70, since they are not assets of the investment bank, are not considered in Zip Code Concentration or similar queries associated with the investment bank's current inventory. However, data associated inactive loans in loan tracking system 70 remain available for subsequent risk assessment and reporting operations.

If the investment bank's bid is accepted, the trader accesses transaction management system 50, finds the deal home page, and inputs this outcome. In one embodiment, transaction management system 50 presents an interface allowing the trader to record the client/originator bank's acceptance for the bid and any deal points negotiated by the trader.

2. Deal Management

A.2.a. Assignment and Notification of Personnel

Transaction management system 50 also includes work flows facilitating management of the processes associated with purchase of the loan pool after acceptance of a bid. When the trader indicates that the bid has been accepted, transaction management system 50 changes the loan status category from “Bid” to “Potential Purchase.” The deal folder remains active and contains the data generated during the bid process (e.g., high risk and portfolio summary reports).

Various users associated with the deal add to the purchase sheet created during the bid process according to their respective roles. The on-line purchase sheet includes a deal-level summary providing authorized internal and external users an overview of deal parameters and timelines. As discussed above, FIGS. 5B1-5B2 include a table indicating the purchase sheet responsibilities of various users associated with a deal.

In one embodiment, the trader is responsible for completing various fields in the purchase sheet (see FIGS. 5B1-5B2). After the trader completes all required fields, notification module 53 transmits an email to the super deal manager, super due diligence manager and the super tape analyst to provide notification that a new purchase transaction has been assigned to them. Since the participation and actions of various users are critical to the work flows, transaction management system 50 supports notification of designees, who are copied on certain email notifications (see Section A.1.b., supra).

The super deal manager, super due diligence manager and super tape analyst each complete the respective fields of the purchase sheet for which they are responsible and assign users to the deal. The super deal manager completes the fields for which she is responsible and assigns the deal to a specific deal manager from a pull-down menu. Assignment of a deal manager triggers notification module 53 to transmit an email notifying the assigned deal manager of the new deal. Similarly, the super due diligence manager completes the requisite purchase sheet fields and assigns a due diligence manager to the deal, triggering a similar email notification. Lastly, the super tape analyst fills in required purchase sheet fields and assigns a tape analyst who is similarly notified.

A.2.b. Deal Set Up Process

The deal manager is responsible for completing the majority of the purchase sheet. He solicits information from internal and external parties to determine key purchase parameters and enters them into the purchase sheet. In one embodiment, the purchase sheet interface includes free form fields and drop-down menus facilitating entry of purchase sheet data. Completion of the purchase sheet triggers notification module 53 to notify the tape analyst, trader, due diligence manager, middle office contact and master servicer contact assigned to the deal. The notification informs these users that the purchase sheet is complete and can be used for reference over the course of closing the deal. In one embodiment, the users may link to the purchase sheet from the deal home page. If any changes are made to the purchase sheet after this initial notification, notification module 53 transmits additional notifications to ensure that the deal work group is notified of changes to deal parameters or timelines.

In response to an email notification, the middle office contact accesses the purchase sheet and sets up an new internal code for the transaction. The internal code is a unique code or identifier for the transaction used by internal users. Once the internal code is assigned, the middle office contact will enter it into the purchase sheet.

As discussed above, transaction management system 50 also maintains an event log stored in the appropriate deal-level folder in document management system 60. The event log allows the deal manager to track deadlines associated with a deal and provide reminders of key events to users. In one embodiment, an interface including input fields for deadlines corresponding to standard tasks associated with deals of this type. The interface also contains a free-form section allowing the deal manager to enter additional tasks and target completion dates.

A.2.c. Expense Reserve Process

Transaction management system 50, in one embodiment, also provides an on-line expense reserve form facilitating management of expenses on a transaction-level basis. In one embodiment, the deal manager is responsible for maintaining the expense reserve form. The deal manager initially completes the form by estimating costs associated with the transaction and entering such estimated costs in appropriate fields in the form. Completion of the expense reserve form triggers notification module 53 to notify the trader that the expense reserve form associated with the transaction is complete and available for review and approval.

The trader accesses the deal home page presented by transaction management system 50 to link to the expense reserve form. In one embodiment, transaction management system 50 presents an interface facilitating entry of the trader's approval or rejection of the tape analyst's expense estimates. Approval of the expense reserve form triggers notification module 53 to transmit an email to the super deal manager that an expense reserve form is completed and available for review. Similarly, the super deal manager accesses the expense reserve form and indicates an approval or rejection of the expense reserve form. In response to the super deal manager's approval of the expense reserve form, notification module 53 transmits an email to the middle office contact providing notification of the expense reserve form. The middle office contact accesses the approved expense reserve form and manually completes the reserve account information.

A.2.d. Selection of Law Firm

Transaction management system 50 also facilitates interactions with external parties to the transaction. For example, investment banks utilize outside legal counsel to assist with preparation of contracts and other documents associated with the transaction. If an outside law firm is utilized for a transaction, the deal manager configures access rights for the selected law firm. In one embodiment, the deal manager enters the selected law firm's contact information into the purchase sheet and requests a password from the systems administrator. In one embodiment, completion of the law firm contact information triggers notification module 53 to transmit an email notification to the systems administrator. The systems administrator creates a user account for the law firm and assigns a password to the selected law firm. As discussed above, the password allows the law firm to access transaction management system 50 in order to download, edit and upload contracts and other documents associated with the transaction according the access privileged defined by the user role associated with the user account.

A.2.e. Document Negotiation Process

The deal manager also decides whether to allow client/originator bank access to transaction management system 50. As above, the deal manager enters contact information for the client/originator bank and the due diligence contacts for the bank and requests passwords from the systems administrator. The passwords allow for access to transaction management system 50 and, thus, documents in document management system 60 limited by the access privileges associated with a user profile. For example, the client/originator bank may access transaction management system 50 to upload transaction documentation.

The deal manager also decides upon what documentation will be used to memorialize the transaction (e.g., the investment bank's documentation or the client originator bank's documentation). If the investment bank's documentation is used, the deal manager may refer to a similar past transaction and copy the documentation associated with that transaction into the current deal folder to use as a starting point.

A.2.f. Custodian Processes

Finalization of the purchase sheet also involves selection of a document custodian. When the purchase sheet is finalized, notification module 53 transmits an email notification to the contact for the selected document custodian that a new transaction has been assigned and is available for review on transaction management system 50. The document custodian may access transaction management system 50 and, in one embodiment, view documents and data associated with the transaction. The document custodian may also access transaction management system 50 to upload an exception report that details the problems associated with the loans in the pool.

A.2.g. Closing

The deal manager monitors the closing date of the transaction throughout the process and makes adjustments to the date as required. Prior to closing, the deal manager also accesses the event log associated with the transaction to ensure that all processes are complete and to note any outstanding tasks or items.

Transaction management system 50 also facilitates notification of a finalized closing date to the users associated with a transaction. For example, once a closing date is finalized and entered by the deal manager, notification module 53 transmits a notification to the trader, middle office contact, tape analyst, due diligence manager, master servicer contact, and super deal manager that closing information associated with the transaction has been updated.

As discussed above, documentation management system 60 stores versions of the transaction documents as they are revised and uploaded into the system. When the transaction documents are finalized and executed, the deal manager or selected law firm uploads the final set of documents in a read-only format. The deal manager may also use transaction management system 50 to purge all draft versions of the transaction documents. Prior to closing, the tape analyst uploads the final tape analyst deal data and reports into the appropriate deal folders in document management system 60. The tape analyst also uploads the final portfolio summary reports and the CAS file into document management system 60.

The super deal manager's signing of the funding memorandum initiates closing of the transaction. In order to track the changes in loan category, the deal manager accesses transaction management system 50 to indicate that the transaction has closed, triggering a change in loan category from “Potential Purchase” to “Owned Asset.” The category of any loans associated with the initial bid pool that are not contained in the final, purchased pool changes to “Inactive-Never Purchased.” In one embodiment, when the deal manager indicates that a deal has closed, transaction management system 50 presents a pop-up box reminding the deal manager to purge draft documents.

A.3. Due Diligence

The due diligence process begins when a trader commits the investment bank to the purchase of a pool of loans. The due diligence process involves a determination of the quality of mortgage loans through detailed investigation of specific data points, such as credit score, loan-to-value ratio, and whether or not the property is in a high-risk zip code. The due diligence manager is responsible for managing loan level due diligence processes to assess the pool from a credit and legal compliance perspective. As discussed in more detail below, due diligence module 56 facilitates selection of a loan sample for more detailed underwriting and appraisal processes, as well as deployment of underwriting and appraisal services.

A.3.a. Assignment Of Due Diligence Manager

As discussed above, when the trader completes requisite sections of the purchase sheet, notification module 53 transmits an email providing notice of the new purchase sheet to the super due diligence manager. The super due diligence manager accesses the purchase sheet, completes all required fields, and selects a due diligence manager from a drop-down menu to trigger an email notification to the selected due diligence manager. Once assigned to the transaction, the due diligence manager begins completion of required fields in the purchase sheet and enters additional information during the sample selection process.

Document management system 60 contains a due diligence manager event log facilitating the tracking of deadlines and completion of required tasks. In one embodiment, transaction management system 50 presents an event log interface including standard due diligence tasks next to fields for entry of target completion dates. The event log interface also has a free-form section allowing the due diligence manager to tailor the event log to various types of transactions.

The deal home page and links associated therewith also allow the due diligence manager to easily verify the performance of various due diligence services and tasks and the presence of associated loan-level and summary reports. In the event that the bid occurred over a short time period and the automated underwriting process was not completed, the due diligence manager has the option to trigger any or all of the following services: 1) High Risk Reports; 2) Fraud Checks; 3) Credit Retrieval; and 4) Automated Underwriting.

A.3.b. Underwriting Sample Selection

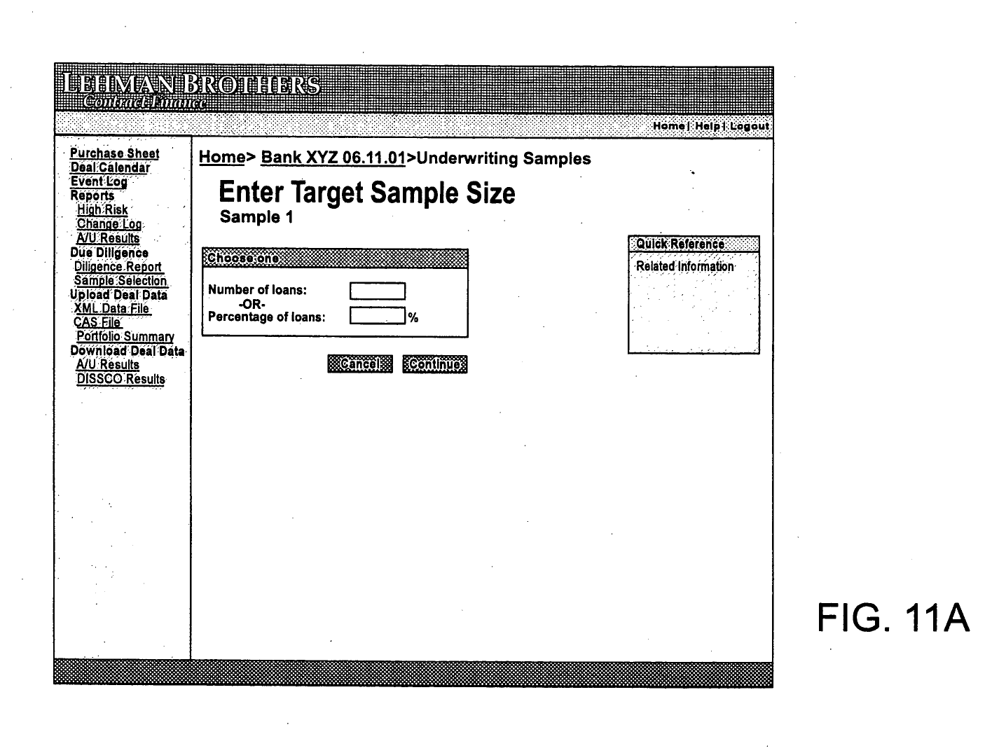

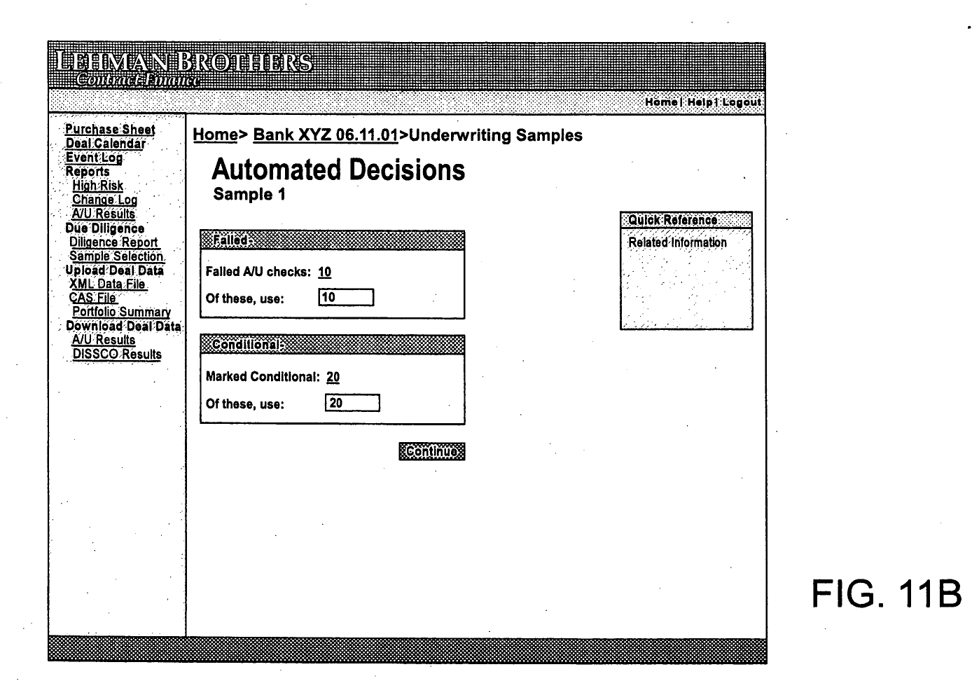

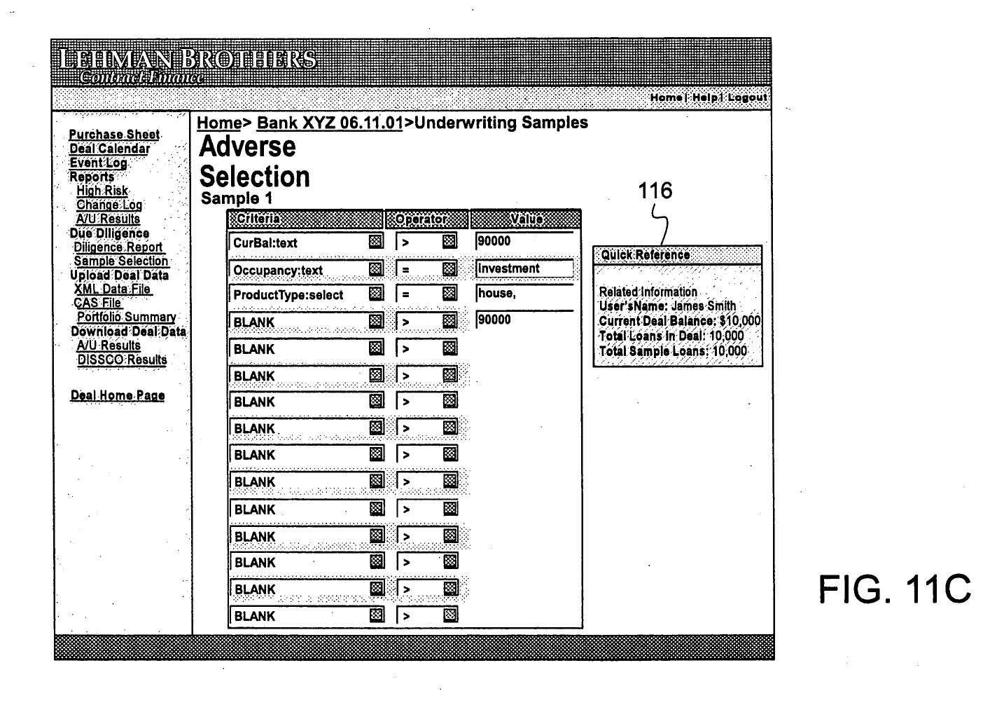

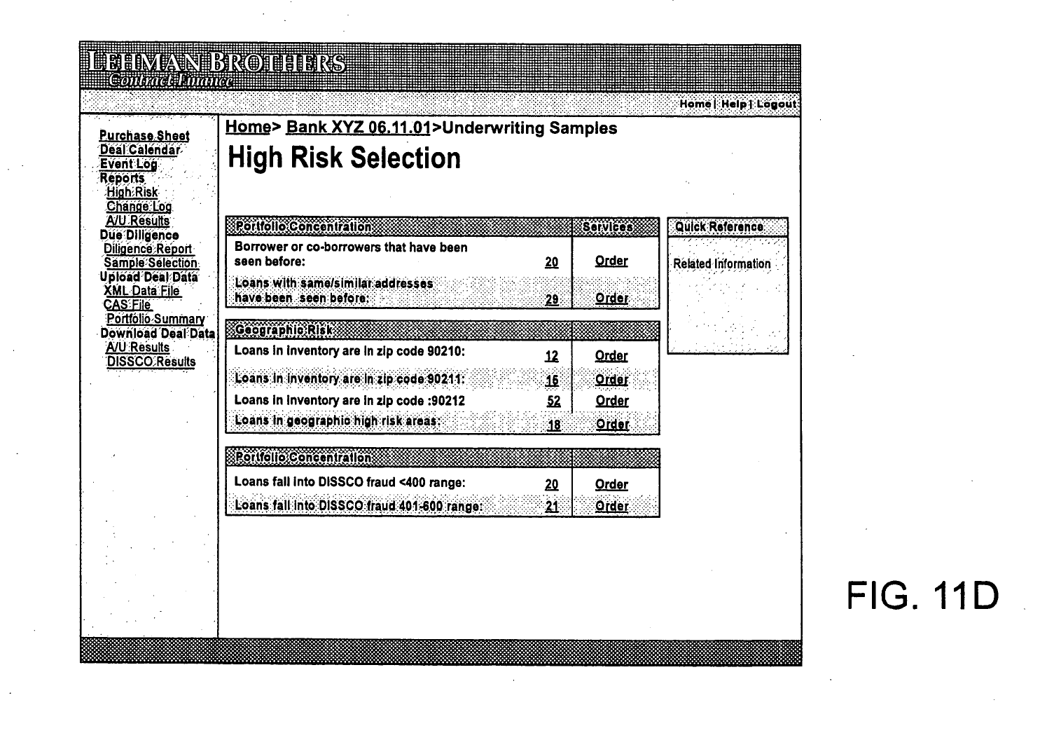

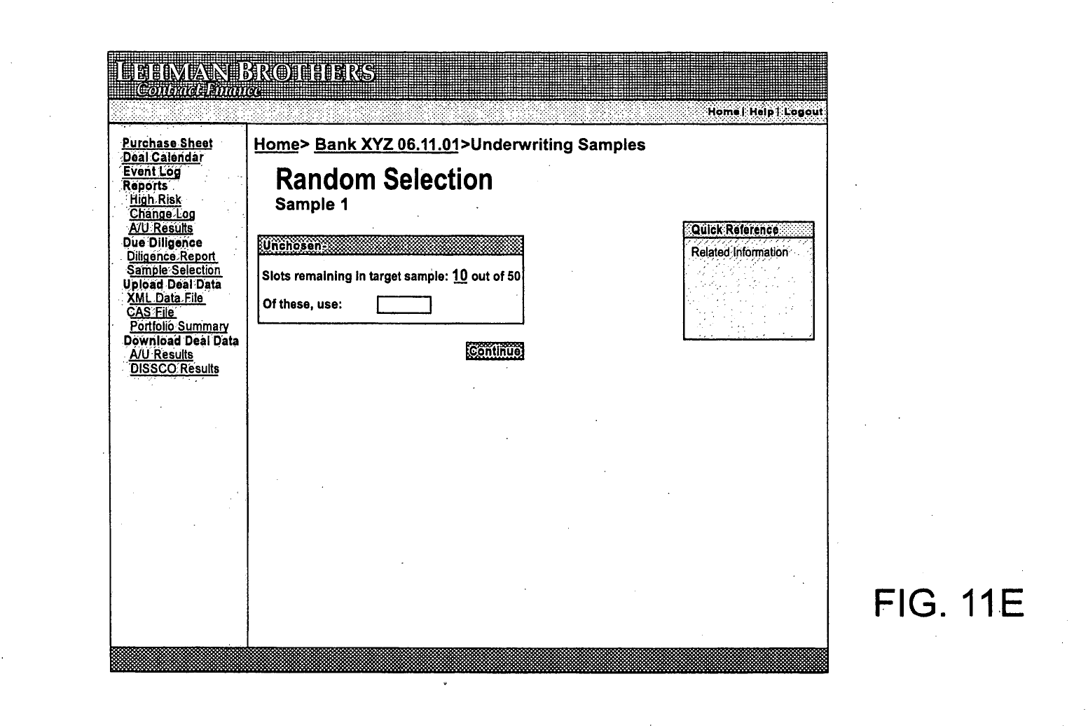

Transaction management system 50 further includes due diligence module 56 that facilitates analysis of summary and loan-level reports to assess the risks associated with the loan pool. In one embodiment, due diligence module 56 includes a sample selection tool that allows the due diligence manager to select a sample of loans based on a hierarchical query method and to select a collection of services to be performed on the sample. The sample selection tool facilitates the selection and configuration of a sample of loans for further analysis both as to due diligence and appraisals. The due diligence manager reviews the results of the high risk and other reports and, using these reports and a general business and credit experience, formulates a sample of loans in the pool to detect and analyze risk associated with the loan pool. The sample selection tool provides an interface allowing the due diligence manager to specify parameters associated with sample selection. See FIGS. 11A-11E. For example, the due diligence manager enters the target underwriting sample size, either as a total number of loans or a percentage of the total loan count (see FIG. 11A).

The selection of a due diligence sample relies on four primary areas: automated underwriting results, adverse selection, high risk results, and random sampling.

Automated Underwriting Results: As to the automated underwriting results, the loan sample tool provides the number of loans in various automated underwriting categories, such as reject, conditional reject, prime, sub-prime, etc. See FIG. 11B. The sample selection tool allows the due diligence manager to select a specific number of loans from each underwriting category and randomly select the specified number of loans from within each category. The sample selection tool also allows the due diligence manager to select a specific loan within each category in order to access a loan-level summary.

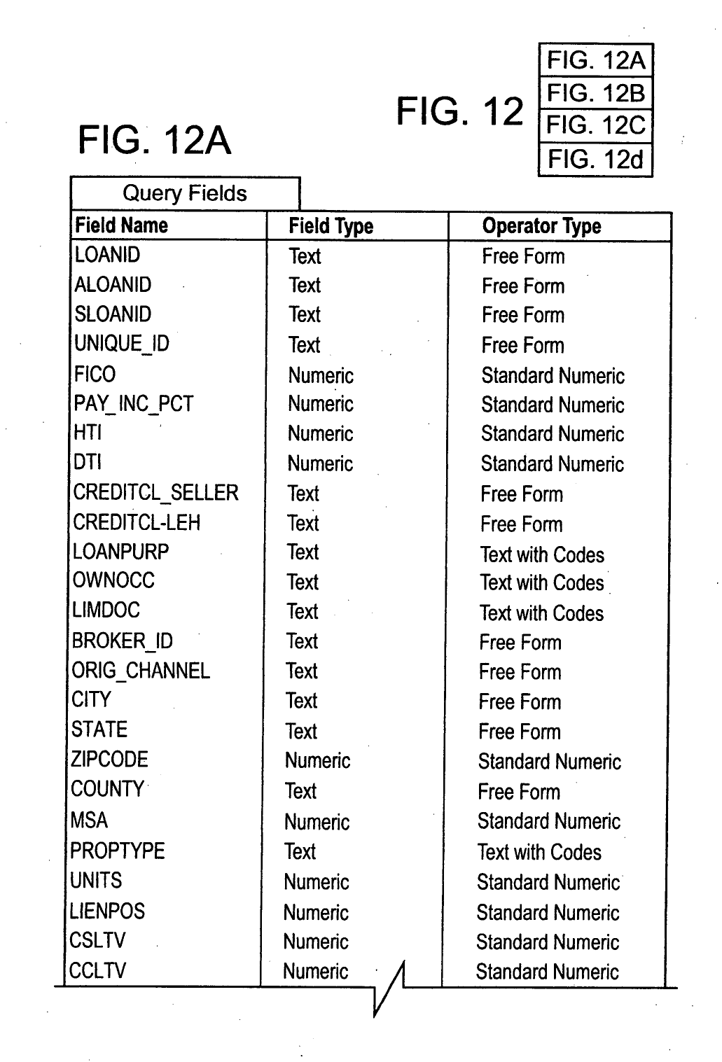

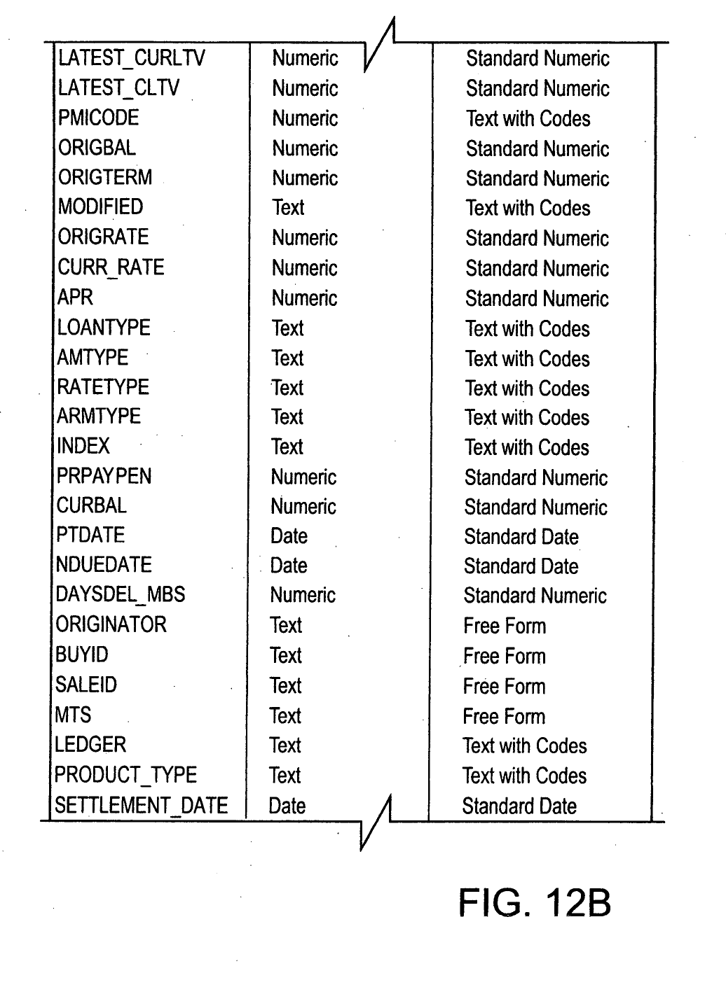

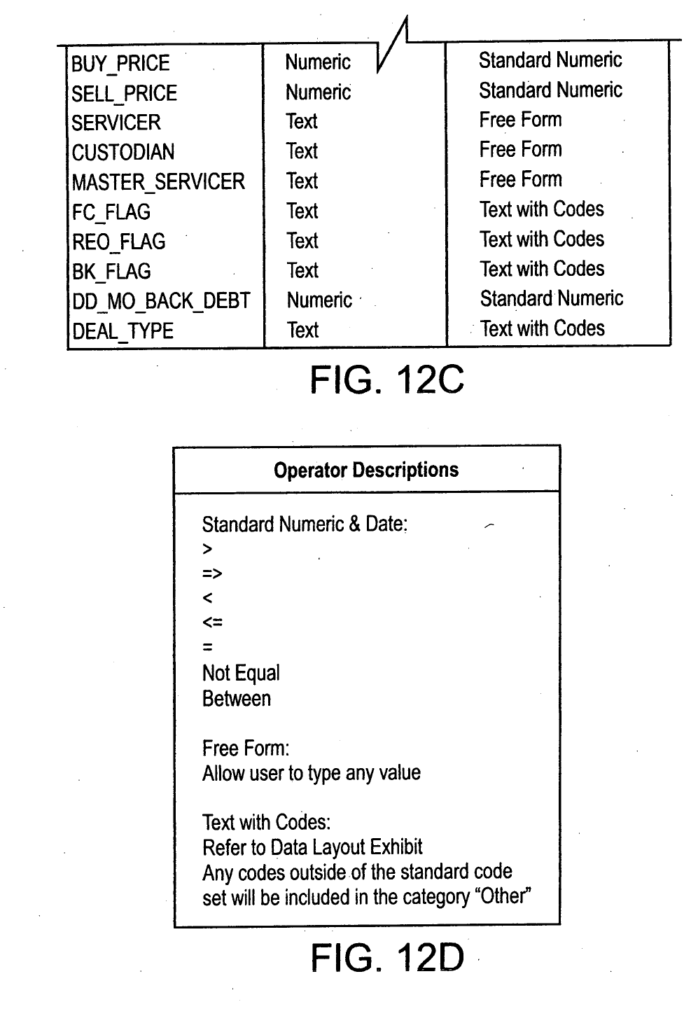

Adverse Selection Query Tool: The adverse selection query allows the due diligence manager to select groups of loans or individual loans based on parameters associated with the risk profile of the loan pool (see FIG. 11C). For example, the adverse selection query interface allows the due diligence manager to select loans based on a numeric field value associated with the loans, such as current balance, loan to value, combined Loan to Value, Debt to Income (DTI) Ratio, Days Delinquent. FIGS. 12A-12D set forth other available numeric fields. The query interface allows the due diligence manager to choose from a standard set of operations and define boundary values for the query. For instance, the due diligence manager may select the DTI field, specify the “greater than” operator and input a boundary value of 60. The adverse selection query will return all loans in the pool with a DTI value greater than 60 percent. The adverse selection query also allows for selection of text fields, such as Property Type, Documentation Type, Origination Channel, Product Type, etc. (see FIGS. 12A-12D). Text fields can either be free-form or code values. As to code values, the query screen provides a pull-down menu facilitating selection of values for each text field based upon a predefined list of codes. In addition, the query interface allows for selection of multiple codes within each text field. In addition, the adverse selection query allows the user to select any combination of text and/or numeric fields. In one embodiment, the query interface presents pull-down menus containing available query fields to facilitate selection of search criteria (see FIG. 11C). In addition, the sample selection tool also allows for querying free form fields. For example, due to its non-standard nature, Credit Grade is available to query in a free form manner. In one embodiment, the due diligence manager may query by credit grade and then type. After the due diligence manager has entered all selection statements, the sample selection tool returns the number of loans in each field search category. Within each field search category, the sample selection tool presents the option to select loans randomly or manually.

High Risk Reports: The results of the high risk report run during the bid process are also available for the selection of a sample group. In one embodiment, the results are displayed as provided above. Within each high risk report category, the due diligence manager has the option to select loans randomly or at the individual loan level. As FIG. 1 ID illustrates, the high risk selection interface, in one embodiment, is based on the following hierarchy: 1) fraud results, 2) high risk areas, 3) portfolio concentrations, 4) borrower concentrations, and 5) zip code concentrations.

Random Sampling: After the due diligence manager has completed the sample selection based on automated underwriting decisions, adverse selection criteria, and high risk report data, transaction management system 50 returns a subtotal of the loan count in the sample. Transaction management system 50 also returns the difference between the target sample size and the number of loans selected according to the query methods described above. Using the sample selection tool, the due diligence manager selects the number of loans to be added to the sample by random selection. See FIG. 11E.

The sample selection tool, in one embodiment, provides sample reference box 116 (see FIG. 11C) on interface screens associated with sample selection to allow the due diligence manager to monitor the progress of sample selection. In one embodiment, sample reference box 116 details the current balance of the transaction, loan count of the entire pool, target loan count for sample, loan count of current sample selection. The sample selection tool also allows the due diligence manager to add loans to the sample if, for example, the target sample size is reached early in the sample selection process and the due diligence manager feels that more loans are necessary. In one embodiment, when the target sample size is reached, the sample selection tool presents a dialogue box informing the due diligence manager that the target size has been reached and provides an option to increase the target sample size.

In addition, the interfaces provided by the sample selection tool facilitate the selection and ordering of services to be executed on various loans at the query category or loan level. For example, for loans in the greater than 60% DTI query category, the sample selection tool allows the due diligence manager to select and order detailed demographic information for all loans in the category or for individual loans in the category. In addition, the sample selection tool also allows the due diligence manager to order national tax verification data to verify income information for borrowers associated with selected loans.

Completion of the due diligence sample for the transaction triggers notification module 53 to notify the deal manager, the tape analyst, the client business contact, the client due diligence contact, and the trader associated with the deal that the underwriting sample is complete and available for viewing. The due diligence manager then selects a due diligence firm and enters its name and relevant contact information into the purchase sheet. The systems administrator is notified to provide a user account and password to the selected due diligence firm. Finalization of the due diligence firm choice triggers an email notification to the due diligence firm that the underwriting sample is complete and available for download.

A.3.c. Appraisal Sample Selection

The sample selection tool also includes functionality facilitating the selection of sample loans for appraisal services. The appraisal sample selection process is similar to the underwriting sample query. The due diligence manager reviews the results of the high risk report detailing areas of geographic concentration and risk in light of factors such as property value decline and instability. As above, the due diligence manager selects a sample of loans for appraisal. The sample selection tool, in one embodiment, excludes from the regular appraisal sample selection process any loans associated with a property having a guaranteed appraisal. In one embodiment, transaction management system 50 includes a loan matching tool that receives a list of loans associated with a guaranteed appraisal program and flags matching loans in loan tracking system 70 as loans having guaranteed appraisals, thereby enabling their exclusion by the sample selection tool.

As above, the due diligence manager specifies a target appraisal sample size using an interface presented by the sample selection tool. The appraisal sample, in one embodiment, is obtained from three primary query methods: 1) adverse selection, 2) geographic high risk areas, and 3) random sampling. Adverse selection querying, in one embodiment, is identical to that described above.

Geographic High Risk Areas: As discussed above, the high risk report identifies the loans whose properties are in high risk areas. Specifically and in one embodiment, the zip codes of the properties in the loan pool are cross-referenced against a predefined list of zip codes associated with high risk areas. The report also includes the number of properties in the loan pool that are located in each high risk area. The interface provided by the sample selection tool allows the due diligence manager to select a random number of these properties or specific properties at the loan level.

Random Sampling: After the due diligence manager has composes a sample using the adverse selection and geographic area query tools described above, the sample selection tool returns the loan count in the current sample and the difference between the current loan count and the target sample size. The due diligence manager, using the sample selection interface, selects the number of loans to add from the pool by random selection.

As described above, as to each query method, the sample selection tool allows for the selection of services to be performed on loans individually or at the query level. For example, within the geographic high risk area query, appraisal valuations for the entire result set or for selected individual loans in the result set. In one embodiment, requests for services, such as appraisal valuations, are composed as XML requests by network services gateway 55 and transmitted to the appraisal service chosen by the due diligence manager. The appraisal service performs automated and/or manual appraisal operations and returns a response. Network services gateway 55, in one embodiment, receives the response and enters the appraisal valuation data in appropriate fields associated with each loan in loan tracking system 70. In one embodiment, the appraisal valuation service implements an appraisal valuation model.

Completion of the appraisal sample triggers notification module 53 to notify the deal manager, the tape analyst, the client business contact, and the client due diligence contact that an appraisal sample is available for review. The due diligence manager will also select an appraisal firm and enter the name and contact information of the appraisal firm into the purchase sheet, triggering notification of the selected appraisal firm by email that the appraisal sample is complete and available for download at the web site.

A.3.d. Upload of Due Diligence Information

As is conventional, the due diligence firm assigned to the transaction sends out its underwriters to review the contents of the loan files and to recommend an underwriting decision. In one embodiment, the recommended underwriting decision is reduced to one of three due diligence status codes: Accept (Status 1), Caution (Status 2), or Reject (Status 3):

On a daily or other periodic basis, the due diligence firm accesses transaction management system 50 to upload results in an XML response. Network services gateway 55 receives the XML response and imports the data into loan tracking system 70 in association with the corresponding loans. For fields that are specific to the underwriting process, transaction management system 50 allows them to be overwritten subject to certain data integrity and error checking validations. Transaction management system 50 only allows selected fields provided by the client/originator bank during the bid or transaction negotiation process to be overwritten by due diligence data. All overwrites are subject to the same validations for standard, imports and exports from loan tracking system 70.

Presentation engine 57 is operative to extract due diligence data from loan tracking system 70 to generate a due diligence summary report. In one embodiment, a due diligence summary report contains underwriting data for the loans associated all active transactions assigned to the due diligence manager. Presentation engine 57 is also operative to generate transaction-level reports. In one embodiment, the report includes links to detailed due diligence information for each loan. In one form, the loan-level data includes the fields set forth in FIG. 7. In one form, the interface allows the due diligence manager to sort according to any displayed field.

A.3.e. Retrieval of Appraisal Data

Similar to underwriting results, appraisal data is retrieved, in one embodiment, as individual appraisals are completed and uploaded to transaction management system 50. In one form, the appraisal results are transmitted as an XML document. Network services gateway 55 imports the appraisal data into loan tracking system 70 in association with corresponding loans. As described above, presentation engine 57 is operative to extract appraisal data from loan tracking system 70 to generate a summary report. In one embodiment, an appraisal summary report contains appraisal data for the loans associated all active transactions assigned to the due diligence manager. Presentation engine 57 is further operative to perform and report certain calculations on appraisal data. For example, based on the property value obtained from the appraisal firm, presentation engine 57 calculates the percentage variance between the appraisal value provided by the client/originator bank and the value provided by the appraisal firm. Presentation engine 57 groups loans based on the calculated appraisal variance. In one embodiment, presentation engine 57 groups loans into a high variance group and a low variance group. A threshold variance (e.g., 15 percent) defines the separation between the two groups. In one embodiment, presentation engine 57 also flags the high variance group as reject, while loans associated with the low variance group are deemed acceptable for purchase.

A.3.f. Finalization of Due Diligence Results

As the due diligence manager receives underwriting and appraisal results, (s)he reviews the status decisions and verifies that Status 3 and “high variance” decisions are accurate. When a complete set of underwriting and appraisal results for a transaction have been returned, the due diligence manager makes desired changes to the status decisions and compiles a list of potential rejects.

In one embodiment, the loan-level and summary reports include fields facilitating modification of status decisions with respect to a loan or group of loans. In one embodiment, the due diligence manager accesses the loan-level sections of the Underwriting and Appraisal Summary Reports to make modifications to the results generated by the due diligence firms and the appraisal firms. For instance, after reviewing underwriting results, the due diligence manager may decide to change a Status 2 loan to Status 1. Similarly, the due diligence manager may change an appraisal value, causing a change in appraisal variance and acceptance status. The due diligence manager's changes are reflected in loan tracking system 70. In one embodiment, loan tracking system 70 locks associated records to prevent further changes by data submitted by the due diligence firms.

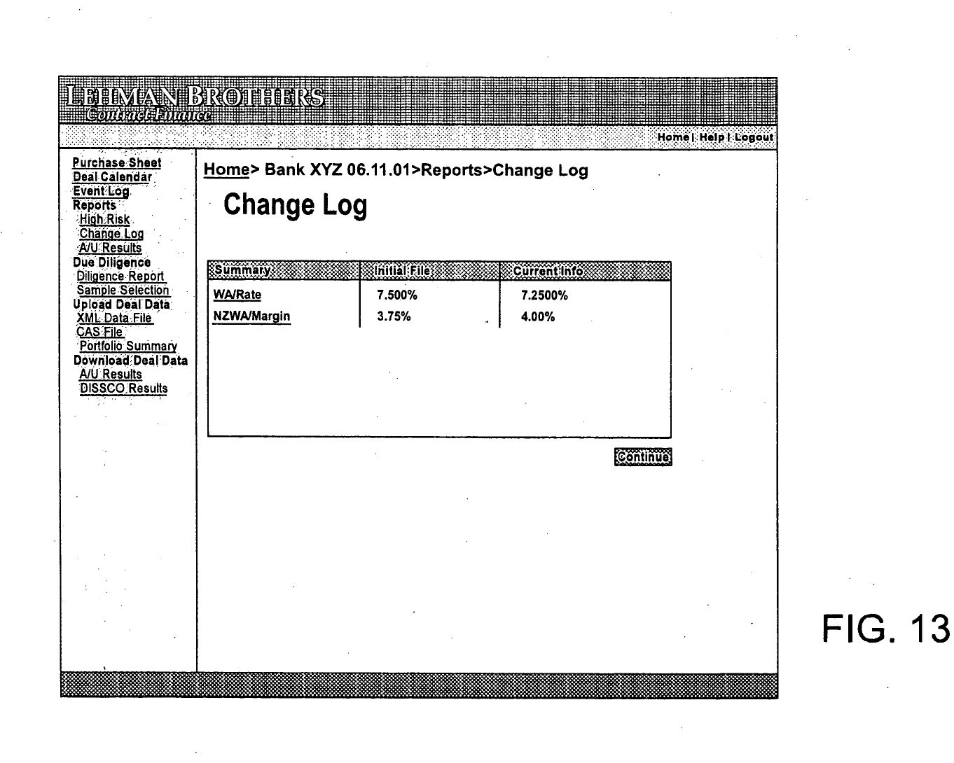

After the due diligence manager finalizes the list of potential rejects, (s)he negotiates the list of rejects with the client due diligence contact. After the client due diligence contact signs off on the list of rejects, the due diligence manager accesses transaction management system 50 to enter the status of each rejected loan in loan tracking system 70. When completed, the due diligence manager accesses the deal home page and clicks on a link to trigger a notification that due diligence for the transaction is complete. In one embodiment, notification module 53 transmits an email notification to the tape analyst, trader and deal manager. The tape analyst accesses the final list of rejected loans from the deal home page in order to remove the rejected loans from the final analytics (e.g., CAS) file. Presentation engine 57 is also operative to generate a transaction-level change log report providing a summary of changes made to pricing variables (such as coupon and margin) resulting from due diligence and analysis processes. See FIG. 13. Of course, the change log can also track changes to a variety of other pricing variables. The trader uses the change log report to assess the impact of the changes and determine if re-pricing of the loan pool is required.

B. Whole Loan Selling

Transaction management system 50 also includes functionality that supports and facilitates the selling of whole loans. An investment bank typically purchases packages of loans, holds the loans for a period of time, and then sells the loans. The sale of loans can either be to a third party (“whole loan sale”) or to a trust (“securitization”).

B.1. Creating a Pool of Loans for Potential Sale

B.1.a. Creation of Deal Folder

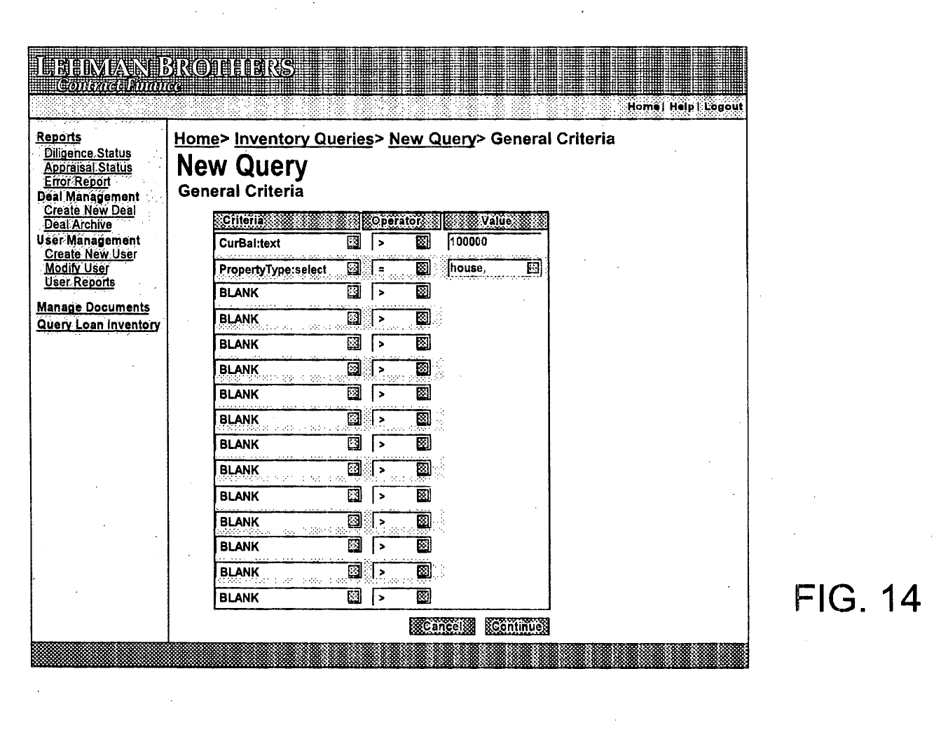

The tape analyst accesses transaction management system 50 to create a new deal folder. In one embodiment, the folder is labeled with the name of a potential buyer and the date. In the event that a specific buyer is not yet identified, the tape analyst labels the deal by product type and date. The tape analyst then uses query and analysis tools (such as a CAS system) to screen and select loans for the package of loans to sell. In one embodiment, tape analyst module 58 includes a query interface (see FIG. 14) that allows the tape analyst to search the loan data fields and use the operators set forth in FIGS. 12A-12D. Tape analyst module 58 is further operative to assemble the loan pool data into a suitable format, such as a CSV file, for analysis by potential purchasers. The tape analyst then generates collateral analysis summary reports describing the package and uploads loan level and summary reports into the deal folder on document management system 60.

After a pool of loans has been selected, the tape analyst uploads loan level data containing economic and non-economic data to be used in the sale process. In one embodiment, the uploaded loan data file will be in XML format, allowing network services gateway 55 to import the data into loan tracking system 70. The completeness of the data set will vary from pool to pool. All loans included in the pool should be part of the investment bank's current inventory or stated for purchase (i.e., loan category is equal to “Owned Asset” or “Potential Purchase”).

B.1.b. Purchase Sheet Creation and Assignment of Personnel

The trader is responsible for completing specific sections of the purchase sheet as detailed in FIGS. 5B1-5B2. After the trader completes the fields for which he or she is responsible, notification module 53 transmits an email notification to the super due diligence manager, super deal manager and super tape analyst that a new purchase sheet has been created and is available for review. The trader's completion of the specific sections of the PS triggers a change in the loan category for all loans in the file uploaded by the tape analyst from “Owned Asset” to “Potential Sale.” As with whole loan purchasing the super deal manager, super tape analyst, and super due diligence manager fill out those sections of the purchase sheet for which they are responsible and assign a deal manager, tape analyst and due diligence manager, respectively to the potential sale transaction. Such assignments trigger notification module 53 to notify the assigned parties by email.

As discussed above, the deal manager is responsible for completing the majority of the purchase sheet. (S)he solicits information from internal and external parties to determine key transaction parameters and enters them into the purchase sheet. In one embodiment, the purchase sheet interface includes free form field and drop-down menus facilitating entry of purchase sheet data. Completion of the purchase sheet triggers notification module 53 to notify the tape analyst, trader, due diligence manager, middle office contact and master servicer contact assigned to the deal. The notification informs these users that the purchase sheet is complete and can be used for reference over the course of closing the deal. In one embodiment, the users may link to the purchase sheet from the deal home page. If any changes are made to the purchase sheet after this initial notification, notification module 53 transmits additional notifications to ensure that the deal work group is notified of changes to deal parameters or timelines.

Document management system 60 maintains a sales event log for the sales process in the appropriate deal-level folder. The deal manager and due diligence manager utilize the consolidated event log to track deadlines associated with the transaction and to provide reminders of key events. Interfaces associated with the sales event log are substantially the same as the event logs discussed above. The deal manager and due diligence manager are able to input target completion dates for standard tasks in order to fit the template to specific deals. The sales event log interface will contain a free form field in which the deal manager or due diligence manager can enter additional tasks as well as target completion dates, allowing the deal manager or due diligence manager to tailor the workflow to various types of deals.

Other aspects of the purchase process are also the same as the purchasing process. For example, transaction management system 50 supports functionality facilitating the creation and maintenance of an expense reserve form (see Section A.2.c., supra). As discussed above, transaction management system 50 also supports tasks associated with the selection of outside legal counsel (Section A.2.d.), management of documents during the negotiation process (Section A.2.e.), and the selection of document custodians (Section A.2.f.).

B.1.c. Closing

The functionality facilitating processes associated with closing a sale transaction are substantially the same as the whole loan purchasing functionality. However, when the deal manager accesses transaction management system 50 to indicate that the deal has closed, workflow management module 52 triggers a change in loan category for all loans in the final closing pool from “Owned Asset” to “Sold Asset.” The loan category of any loans present in the initial sale pool that are not in the final universe remain as “Owned Asset.”

Lastly, although the present invention has been described as operating in connection with the purchase and sate of whole loans, the present invention has application to a variety of financial transactions. For example, the present invention can support the lending activities of a bank in its due diligence processes associated with analysis of proffered collateral. Moreover, embodiments of the present invention can facilitate processes associated with the securitization of loans, such as the generation of summary reports, selection of underwriting and appraisal samples, and the utilization of transaction documents in the document management system. Accordingly, the present invention has been described with reference to specific embodiments. Other embodiments of the present invention will be apparent to one of ordinary skill in the art. It is, therefore, intended that the claims set forth below not be limited to the embodiments described above.

What is claimed:

1. An apparatus facilitating analysis of a pool of loans, comprising:
a loan tracking system operative to store loan-level data in association with corresponding loans in a portfolio; and
a tape analyst module operative to compare a pool of loans against remaining loans in the loan tracking system to allow for a determination of how acquisition of the pool of loans would affect the risk profile of the resulting portfolio.

2. The apparatus of claim 1, wherein the loan tracking system maintains loan-level data for inactive loans outside the portfolio, and wherein the tape analyst module is operative to compare the pool of loans against the inactive loans.

3. The apparatus of claim 2, wherein the tape analyst module is operative to determine whether any borrower associated with a loan in the pool is associated with an active or inactive loan in the loan tracking system.

4. The apparatus of claim 2, wherein the tape analyst module is operative to identify loans in the pool having matching addresses with loans in the loan tracking system.

5. The apparatus of claim 2, wherein the tape analyst module is operative to determine the number of loans in the pool whose properties lie in the same zip code as active loans in the portfolio.

6. The apparatus of claim 2, wherein the tape analyst module facilitates generation of requests to a fraud scoring application operative to assign a fraud score to selected loans in the pool.

7. The apparatus of claim 2, wherein the tape analyst module facilitates generation of requests to an automated underwriting application service operative to segregate the pool of loans into predefined categories based on an underwriting rule set.

8. The apparatus of claim 1 further comprising a presentation engine operative to generate a report detailing how acquisition of the pool of loans affects the risk profile of the portfolio of active loans.
